(19) United States
(12) Patent Application Publication
(10) Pub. No.: US 2026/0238722 A1
(43) Pub. Date: Aug. 13, 2026

(54) METHOD AND SYSTEM FOR AI-BASED NODE TRAVERSAL RECALIBRATION IN INTERACTIVE VOICE RESPONSE SYSTEM

(71) Applicant: BANK OF AMERICA CORPORATION, Charlotte, NC (US)

(72) Inventors: Rajesh Sinha, Gurugram (IN); Nipun Mahajan, Lawrenceville, NJ (US); Amit Mishra, Chennai (IN); Yogesh Raghuvanshi, Pennington, NJ (US); Sushama Deepak Shelke, Mumbai (IN)

(73) Assignee: BANK OF AMERICA CORPORATION, Charlotte, NC (US)

(21) Appl. No.: 19/048,404

(22) Filed: Feb. 7, 2025

(51) Int. Cl. H04M 3/493; G10L 15/16

(52) U.S. Cl. CPC H04M 3/4936; G10L 15/16; H04M 2203/10; H04M 2203/558

(57) ABSTRACT

Systems, computer program products, and methods are described herein for AI-based node traversal recalibration in Interactive Voice Response system. The present disclosure is configured to receive, using a contextual verbiage engine, an input, wherein the input is a user utterance or a refined text based on the user utterance, to identify a user intent and an intent module associated with the user intent from the input, to determine a current node based on the user intent and the intent module, and a node traversal map associated with the current node, to determine alignment of the current node with an actual user intent, using an AI-based pre-trained model, based on the node traversal map and node traversal knowledge bases, and to execute, in an instance where the current node fails to align with the actual user intent, an utterance recognition refinement engine.

### TECHNOLOGICAL FIELD

Example embodiments of the present disclosure relate to AI-based node traversal recalibration system in interactive voice response (IVR) system.

### BACKGROUND

Interactive Voice Response (IVR) systems are widely used across industries to provide automated telephony solutions for handling caller inquiries, managing call routing, and enabling self-service functionalities. While conventional IVR systems are effective in managing basic tasks, they frequently encounter limitations when handling complex user interactions, often resulting in the call being routed to a live agent. These limitations stem from static workflows, rigid decision-making processes, and the inability to leverage large-scale user interaction data for continuous improvement. Therefore, there is a need to enhance IVR systems to increase flexibility in identifying callers'requests and to foster more meaningful interactions with callers.

Applicant has identified a number of deficiencies and problems associated with the conventional IVR system. Through applied effort, ingenuity, and innovation, many of these identified problems have been solved by developing solutions that are included in embodiments of the present disclosure, many examples of which are described in detail herein.

### BRIEF SUMMARY

Systems, methods, and computer program products are provided for the AI-based node traversal recalibration system in IVR system.

In one aspect, a system for AI-based node traversal recalibration system in the IVR system. In some embodiments, the system may comprise: a memory device with computer-readable program code stored thereon; and at least one processing device operatively coupled to at least one memory device, wherein executing the computer-readable code is configured to cause the at least one processing device to: receive, using a contextual verbiage engine, an input, wherein the input is a user utterance or a refined text based on the user utterance; identify a user intent and an intent module associated with the user intent from the input; determine a current node based on the user intent and the intent module, and a node traversal map associated with the current node; determine alignment of the current node with an actual user intent, using an AI-based pre-trained model, based on the node traversal map and node traversal knowledge bases; and execute, in an instance where the current node fails to align with the actual user intent, an utterance recognition refinement engine, wherein the utterance recognition refinement engine is configured to: receive the user utterance; generate the refined text based on the user utterance; and transmit the refined text to the contextual verbiage engine.

In some embodiments, executing the computer-readable program code is further configured to cause the at least one processing device to: execute, in an instance where the current node aligns with the actual user intent, the intent module using an application programming interface (API) associated with the intent module.

In some embodiments, the node traversal knowledge bases comprise a node traversal map database, a predictive node traversal map model, a node information database, or at least one of user activity record associated with the user.

In some embodiments, executing the computer-readable program code is further configured to cause the at least one processing device to: request, using the contextual verbiage engine, a confirmation whether the user intent aligns with the actual user intent to the user via the user device; and execute the intent module using the API associated with the intent module or the utterance recognition refinement engine, wherein, in an instance where the user confirms the user intent aligns with the actual user intent, execute the intent module, or wherein, in an instance where the user confirms the user intent fails to align with the actual user intent, execute the utterance recognition refinement engine.

In some embodiments, executing the computer-readable program code is further configured to cause at least one processing device to use a centralized system, wherein the centralized system comprises computational resources and is configured to: orchestrate at least one subsystem and the computational resources; assign the user to the subsystem, wherein the subsystem is configured to interact with the user and customize the computational resources for the user; receive user interaction data associated with the user from the subsystem; and update the computational resources based on the user interaction data.

In some embodiments, executing the computer-readable program code is further configured to cause at least one processing device to execute training of the AI-based pre-trained model using a supervised deep learning transformer algorithm.

In some embodiments, executing the computer-readable program code is further configured to cause at least one processing device to route the user to an agent, in an instance where the repetition of a node traversal recalibration process for the current node exceeds a predefined number.

In some embodiments, executing the computer-readable program code is further configured to cause at least one processing device to use the contextual verbiage engine to: receive, via the user device, the input from the user in a form of at least one of audio, text, image, or video; and transmit, via the user device, a response associated with the user intent in the form of at least one of audio, text, image, or video.

In some embodiments, the node information database comprises node information associated with the current node, wherein the node information comprises node rules, an average handling time, and a call transfer rate.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for the AI-based node traversal recalibration system in the interactive voice response (IVR) system, in accordance with an embodiment of the disclosure.

FIG. 2 illustrates an exemplary machine learning (ML) subsystem architecture, in accordance with an embodiment of the invention.

FIG. 3 illustrates an exemplary generative AI subsystem, in accordance with an embodiment of the invention.

FIG. 4 illustrates an example node traversal recalibration system diagram in the IVR system, in accordance with an embodiment of the disclosure.

FIG. 5 illustrates an example high-level architecture diagram for the AI-based node traversal recalibration system in the IVR system, in accordance with an embodiment of the disclosure.

FIG. 6 illustrates a process flow for recalibrating the node traversal in the IVR system using the AI-based engines, in accordance with an embodiment of the disclosure.

FIG. 7 illustrates a process flow for requesting confirmation from the user regarding the current node, in accordance with an embodiment of the disclosure.

FIG. 8 illustrates a process flow for recognizing the user utterance using the AI engines, in accordance with an embodiment of the disclosure.

FIG. 9 illustrates a process flow for suppressing the noise in the user utterance using the AI engines, in accordance with an embodiment of the disclosure.

FIG. 10 illustrates a process flow for operating a hierarchical system in the node traversal recalibration system and the utterance recognition refinement system, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, an “engine” may refer to core elements of an application, or part of an application that serves as a foundation for a larger piece of software and drives the functionality of the software. In some embodiments, an engine may be self-contained, but externally controllable code that encapsulates powerful logic designed to perform or execute a specific type of function. In one aspect, an engine may be underlying source code that establishes file hierarchy, input and output methods, and how a specific part of an application interacts or communicates with other software and/or hardware. The specific components of an engine may vary based on the needs of the specific application as part of the larger piece of software. In some embodiments, an engine may be configured to retrieve resources created in other applications, which may then be ported into the engine for use during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

Traditional interactive voice response (IVR) systems operate with static workflows and rigid decision-making processes, making them vulnerable to complex user requests. Additionally, they often lack the ability to adapt to real-time user intent, resulting in limited flexibility and an increased need for live agent intervention. Furthermore, traditional IVR systems are unable to effectively leverage large-scale user interaction data for continuous improvement, limiting their capacity to personalize interactions or enhance overall performance.

One of the reasons for the failure to adapt to user's intent is the interruption of the user utterance by communicational noise or background noise (e.g., poor quality call connection, background sound, and/or the like) or the speech characteristics that deviate from speech clarity. The IVR system can modify its process if it detects in real-time that the recognized user intent does not align with the actual user intent, further revising the user utterance to correctly recognize the user intent.

Accordingly, the present disclosure incorporates a node traversal recalibration system into the IVR system to track the user's intent in real-time and recalibrate call nodes as necessary. The disclosure extracts user intent from the user utterance and generates a current node and a node traversal map to execute the user intent. During the process, the disclosed invention determines whether the current node aligns with the actual user intent using an AI based pre-trained model based on a past node traversal database, a predicted node traversal model, and a node information database. The AI based pre-trained model may be trained using supervised deep learning transformer algorithms operated within the centralized system of the disclosure. In cases where the current node is determined to fail to align with the actual user intent, the disclosed invention utilizes an utterance recognition refinement system to refine the user utterance and create a new node, whereby replacing the current node that recalibrates the node traversal.

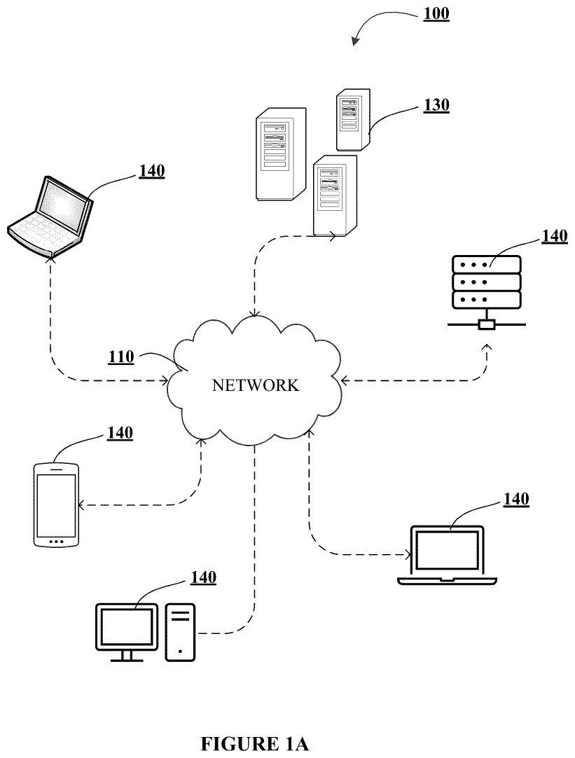

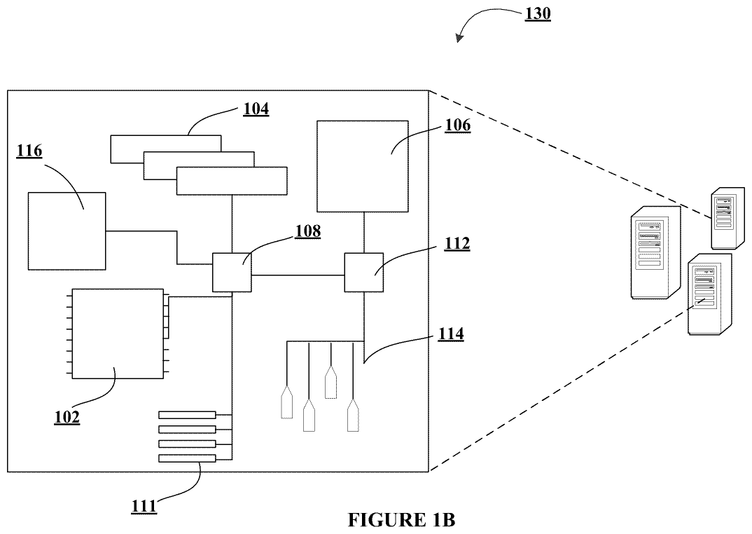

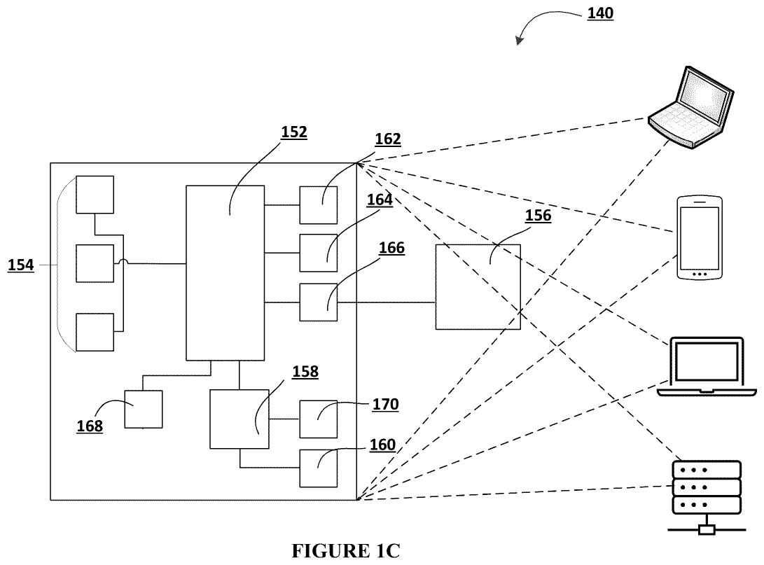

FIGS. 1A-1C illustrate technical components of an exemplary distributed computing environment for the AI-based node traversal recalibration system 100 in the IVR system, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, entertainment consoles, mainframes, or the like, or any combination of the aforementioned.

The end-point device(s) 140 may represent various forms of electronic devices, including user devices or user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 106. The system 130 may also include a high-speed interface 108 connecting to the memory 104, and a low-speed interface 112 connecting to low speed bus 114 and storage device 106. Each of the components 102, 104, 106, 108, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 106, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation- and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

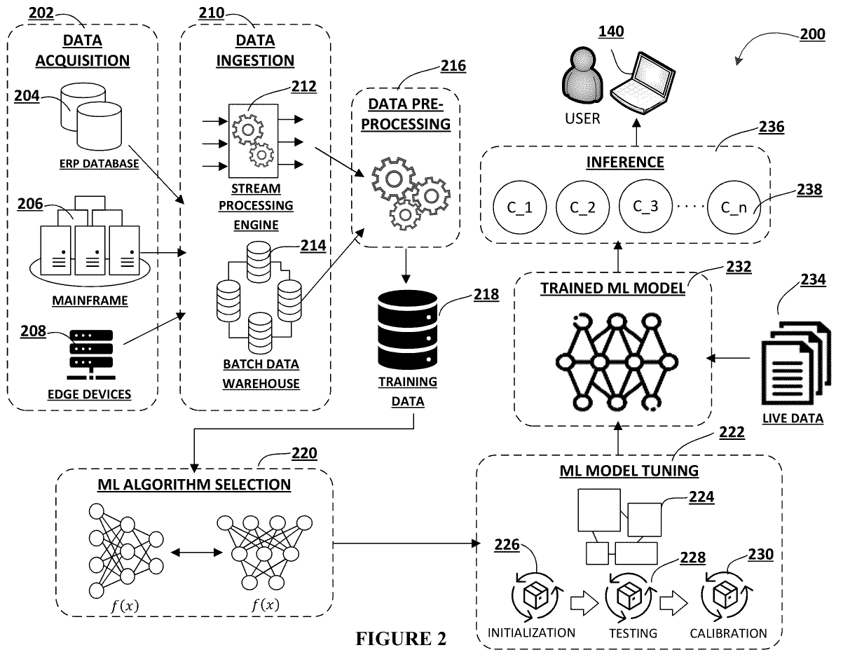

FIG. 2 illustrates an exemplary machine learning (ML) subsystem architecture 200, in accordance with an embodiment of the invention. The machine learning subsystem 200 may include a data acquisition engine 202, data ingestion engine 210, data pre-processing engine 216, ML model tuning engine 222, and inference engine 236.

The data acquisition engine 202 may identify various internal and/or external data sources to generate, test, and/or integrate new features for training the machine learning model 224. These internal and/or external data sources 204, 206, and 208 may be initial locations where the data originates or where physical information is first digitized. The data acquisition engine 202 may identify the location of the data and describe connection characteristics for access and retrieval of data. In some embodiments, data is transported from each data source 204, 206, or 208 using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources 204, 206, and 208 may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 202 from these data sources 204, 206, and 208 may then be transported to the data ingestion engine 210 for further processing.

Depending on the nature of the data imported from the data acquisition engine 202, the data ingestion engine 210 may move the data to a destination for storage or further analysis. Typically, the data imported from the data acquisition engine 202 may be in varying formats as they come from different sources, including RDBMS, other types of databases, S3 buckets, CSVs, or from streams. Since the data comes from different places, it needs to be cleansed and transformed so that it can be analyzed together with data from other sources. At the data ingestion engine 202, the data may be ingested in real-time, using the stream processing engine 212, in batches using the batch data warehouse 214, or a combination of both. The stream processing engine 212 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 214 collects and transfers data in batches according to scheduled intervals, trigger events, or any other logical ordering.

In machine learning, the quality of data and the useful information that can be derived therefrom directly affects the ability of the machine learning model 224 to learn. The data pre-processing engine 216 may implement advanced integration and processing steps needed to prepare the data for machine learning execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 216 may implement feature extraction and/or selection techniques to generate training data 218. Feature extraction and/or selection is a process of dimensionality reduction by which an initial set of data is reduced to more manageable groups for processing. A characteristic of these large data sets is a large number of variables that require a lot of computing resources to process. Feature extraction and/or selection may be used to select and/or combine variables into features, effectively reducing the amount of data that must be processed, while still accurately and completely describing the original data set. Depending on the type of machine learning algorithm being used, this training data 218 may require further enrichment. For example, in supervised learning, the training data is enriched using one or more meaningful and informative labels to provide context so a machine learning model can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points.

The ML model tuning engine 222 may be used to train a machine learning model 224 using the training data 218 to make predictions or decisions without explicitly being programmed to do so. The machine learning model 224 represents what was learned by the selected machine learning algorithm 220 and represents the rules, numbers, and any other algorithm-specific data structures required for classification. Selecting the right machine learning algorithm may depend on a number of different factors, such as the problem statement and the kind of output needed, type and size of the data, the available computational time, number of features and observations in the data, and/or the like. Machine learning algorithms may refer to programs (math and logic) that are configured to self-adjust and perform better as they are exposed to more data. To this extent, machine learning algorithms are capable of adjusting their own parameters, given feedback on previous performance in making prediction about a dataset.

The machine learning algorithms contemplated, described, and/or used herein include supervised learning (e.g., using logistic regression, using back propagation neural networks, using random forests, decision trees, or the like), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, or the like), an instance-based method (e.g., k-nearest neighbor, learning vector quantization, self-organizing map, or the like), a regularization method (e.g., ridge regression, least absolute shrinkage and selection operator, elastic net, or the like), a decision tree learning method (e.g., classification and regression tree, iterative dichotomiser 3, C4.5, chi-squared automatic interaction detection, decision stump, random forest, multivariate adaptive regression splines, gradient boosting machines, or the like), a Bayesian method (e.g., naïve Bayes, averaged one-dependence estimators, Bayesian belief network, or the like), a kernel method (e.g., a support vector machine, a radial basis function, or the like), a clustering method (e.g., k-means clustering, expectation maximization, or the like), an associated rule learning algorithm (e.g., an Apriori algorithm, an Eclat algorithm, or the like), an artificial neural network model (e.g., a Perceptron method, a back-propagation method, a Hopfield network method, a self-organizing map method, a learning vector quantization method, or the like), a deep learning algorithm (e.g., a restricted Boltzmann machine, a deep belief network method, a convolution network method, a stacked auto-encoder method, or the like), a dimensionality reduction method (e.g., principal component analysis, partial least squares regression, Sammon mapping, multidimensional scaling, projection pursuit, or the like), an ensemble method (e.g., boosting, bootstrapped aggregation, AdaBoost, stacked generalization, gradient boosting machine method, random forest method, or the like), and/or the like.

To tune the machine learning model, the ML model tuning engine 222 may repeatedly execute cycles of experimentation 226, testing 228, and tuning 230 to optimize the performance of the machine learning algorithm 220 and refine the results in preparation for deployment of those results for consumption or decision making. To this end, the ML model tuning engine 222 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the model is the measurement used to determine which set of hyperparameters is best at identifying relationships and patterns between variables in a dataset based on the input, or training data 218. A fully trained machine learning model 232 is one whose hyperparameters are tuned and model accuracy maximized.

The trained machine learning model 232, similar to any other software application output, can be persisted to storage, file, memory, or application, or looped back into the processing component to be reprocessed. More often, the trained machine learning model 232 is deployed into an existing production environment to make practical business decisions based on live data 234. To this end, the machine learning subsystem 200 uses the inference engine 236 to make such decisions. The type of decision-making may depend upon the type of machine learning algorithm used. For example, machine learning models trained using supervised learning algorithms may be used to structure computations in terms of categorized outputs (e.g., C_1, C_2 . . . C_n 238) or observations based on defined classifications, represent possible solutions to a decision based on certain conditions, model complex relationships between inputs and outputs to find patterns in data or capture a statistical structure among variables with unknown relationships, and/or the like. On the other hand, machine learning models trained using unsupervised learning algorithms may be used to group (e.g., C_1, C_2 . . . C_n 238) live data 234 based on how similar they are to one another to solve exploratory challenges where little is known about the data, provide a description or label (e.g., C_1, C_2 . . . C_n 238) to live data 234, such as in classification, and/or the like. These categorized outputs, groups (clusters), or labels are then presented to the user input system 130. In still other cases, machine learning models that perform regression techniques may use live data 234 to predict or forecast continuous outcomes.

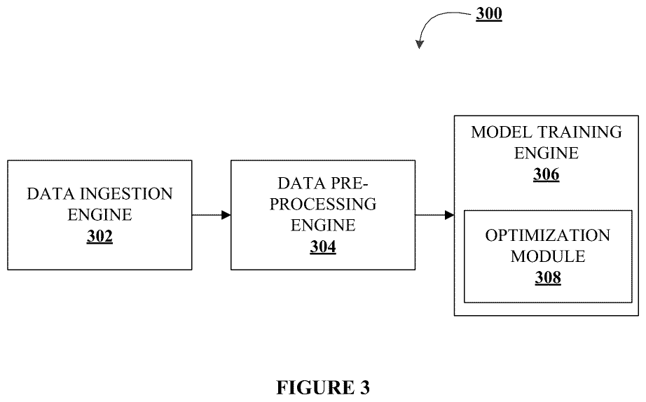

FIG. 3 illustrates an exemplary generative AI subsystem 300, in accordance with an embodiment of the invention. The generative AI subsystem 300 may include a data ingestion engine 302, a data pre-processing engine 304, and a model training engine 306. It should be understood that the generative AI subsystem 300 is merely an example, and other embodiments may include more, fewer, or different components depending on the specific requirements and implementations of the system. For instance, additional engines for data validation, feature selection, or distributed computing may be integrated into the subsystem, or certain components described herein may be consolidated or omitted based on system performance objectives. Therefore, the generative AI subsystem 300 should not be considered limiting and may be adapted to various configurations within the scope of the invention.

The data ingestion engine 302 may identify various internal and/or external data sources to generate, test, and/or integrate new features for training the generative AI model. These internal and/or external data sources (e.g., text corpora, web-based text data, document repositories, or decentralized text storage system) may be initial locations where the data originates or where physical information is first digitized. In addition to conventional data sources, the data ingestion engine 302 may support decentralized storage systems, such as blockchain-based data sources, and privacy-preserving methods such as differential privacy. The data ingestion engine 302 may identify the location of the data and describe connection characteristics for access and retrieval of data. In some embodiments, data is transported from each data source using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the data sources may include Enterprise Resource Planning (ERP) databases that host data related to day-to-day business activities such as accounting, procurement, project management, exposure management, supply chain operations, and/or the like, mainframes that are often the entity's central data processing center, edge devices that may be any piece of hardware, such as sensors, actuators, gadgets, appliances, or machines, that are programmed for certain applications and may transmit data over the internet or other networks, and/or the like.

Depending on the nature of the data, the data ingestion engine 302 may move the data to a destination for storage or further analysis. Typically, the data may be in varying formats as the data comes from different sources, including RDBMS, other types of databases, S3 buckets, CSVs, or from streams. For a large language model (“LLM”), text data may originate from sources such as web scrapes, social media, large public text datasets, or the like. Since the data may come from different places, the data needs to be cleansed and transformed so that the data may be analyzed together with data from other sources. The data may be ingested in real-time, using stream processing, in batches using a batch data warehouse, or in a combination of both. Stream processing may be used to process continuous data streams (e.g., data from edge devices) by computing on data directly as it is received, and filtering the incoming data to retain specific portions that are deemed useful by aggregating, analyzing, transforming, and/or ingesting the data. On the other hand, the batch data warehouse may collect and transfer data in batches according to scheduled intervals, triggered events, and/or any other logical ordering.

The generative AI subsystem 300 may utilize one or more machine learning techniques to generate new content. In machine learning, the quality of data and the useful information that may be derived therefrom directly affects the ability of the machine learning model to learn. The data pre-processing engine 304 may implement advanced integration and processing steps needed to prepare the data for machine learning execution, including tokenization, text normalization, and/or removal of irrelevant elements like HTML tags in web-based data, especially for LLM training. This may include modules to perform any upfront data transformation to consolidate the data into alternate forms by changing the value, structure, and/or format of the data by using generalization, normalization, attribute selection, aggregation, and text-specific transformations such as stemming and lemmatization to data clean by filling missing values, smoothing the noisy data, resolving the inconsistency, removing outliers, and/or any other encoding steps as needed. In some embodiments, the data pre-processing engine 304 may perform real-time pre-processing at the edge via edge computing devices, allowing for the transformation and reduction of data prior to transmission to centralized locations, thereby reducing latency and conserving network bandwidth.

In addition to improving the quality of the data, the data pre-processing engine 304 may transform categorical data into numerical formats that may be suitable for machine learning algorithms. In this regard, the data pre-processing engine 304 may use techniques such as one-hot encoding or label encoding depending on the nature of the categorical variables and the intended use of the data.

In some embodiments, the data pre-processing engine 304 may also include dimensionality reduction techniques, where the number of input features is reduced while retaining the most relevant information. In this regard, the data pre-processing engine 304 may include methods such as Principal Component Analysis (PCA) or apply feature selection algorithms to remove redundant or irrelevant features, thereby reducing the computational complexity of the model training phase. Feature selection may be particularly beneficial in datasets with a high number of features, ensuring that the generative AI models do not overfit to noise or irrelevant details. The pre-processed data output from the data pre-processing engine 304 may then be fed into the model training engine 306.

The model training engine 306 may be responsible for training the generative AI models using the pre-processed data from the data pre-processing engine 304. The model training engine 306 may implement various machine learning algorithms, including but not limited to Generative Adversarial Networks (GANs), Variational Autoencoders (VAEs), transformers, diffusion models, and/or other specialized architectures depending on the specific requirements of the system. These models may be used in a broad range of applications, such as LLMs for text generation, image generation models, video synthesis models, audio generation models, and/or the like. The model training engine 306 may optimize these models by continuously adjusting their internal parameters based on the patterns and relationships identified within the data.

In some embodiments, the model training engine 306 may include a training data handler, which manages the partitioning of the pre-processed data into training, validation, and testing datasets. The training data may be used to update the model's parameters, while the validation and testing datasets may be reserved to evaluate the model's performance during and after training. The model training engine 306 may support various data-handling strategies, such as cross-validation or random shuffling, to ensure that the model generalizes well and is not overfitting to the training data.

In embodiments involving large language models, the model training engine 306 may utilize transformer-based architectures. Transformer models rely on mechanisms like self-attention to capture dependencies between words in a sequence, regardless of their distance from one another. The self-attention mechanism allows the model to weigh the importance of different words in a sentence and establish complex relationships important for understanding context. During training, the model may process vast amounts of text data and learn to predict the next word or token in a sequence based on the input context. This training process allows LLMs to generate coherent text, complete sentences, translate languages, or answer questions based on learned patterns from the data.

The transformer-based LLMs may be trained using autoregressive or masked-language modeling techniques. In autoregressive models, the training process may include predicting the next word in a sequence by progressively revealing more context to the model. The model iteratively improves its predictions based on its performance during prior iterations. Masked-language modeling involves masking certain words in a sentence and training the model to correctly predict the masked words based on surrounding context. Both approaches enable LLMs to capture intricate patterns in human language, improving their ability to handle tasks such as summarization, translation, and text generation. Loss functions like cross-entropy loss may be used to optimize the model's performance by comparing predicted tokens with the actual tokens in the dataset to guide the model to minimize prediction errors during training, as described in further detail herein.

In embodiments involving image generation models, the model training engine 306 may utilize transformer-based architectures, such as Vision Transformers (ViTs) or generative adversarial networks (GANs). Vision Transformers rely on self-attention mechanisms to process images as sequences of patches rather than whole images, allowing the model to capture spatial dependencies and patterns across the image. During training, the model may be exposed to large datasets containing diverse image types to learn features like textures, edges, and shapes. The model may then generate or reconstruct images by interpreting these patterns and applying learned spatial relationships. GAN-based models may also be used, where a generator network creates images, and a determinator network evaluates their realism, enabling the model to improve through adversarial training.

Image generation models may employ various training techniques, such as pixel-wise reconstruction or adversarial training, depending on the architecture. Pixel-wise reconstruction methods involve learning to reconstruct an image from its corrupted or downscaled version, optimizing the model to minimize the difference between the predicted and actual pixels (e.g., using mean squared error as the loss function). Adversarial training, often used with GANs, involves iteratively improving the generator network to produce images that are increasingly indistinguishable from real images, based on feedback from the determinator network. These approaches allow the model to capture complex visual features, enabling applications such as image synthesis, enhancement, and style transfer.

For video generation models, the model training engine 306 may employ transformer-based architectures like Video Transformers or GAN-based models specifically designed for handling temporal sequences. Video Transformers use self-attention mechanisms to model dependencies not only between pixels within a single frame but also across frames, allowing them to understand temporal relationships and motion patterns in videos. The model may be trained on large video datasets, enabling it to learn and reproduce dynamic changes and interactions between objects over time. GAN-based video models. The model may incorporate spatiotemporal networks to evaluate the realism of generated video sequences, optimizing the model to produce continuous and coherent frames.

Video generation models may utilize spatial-temporal modeling techniques or adversarial training for generating realistic motion and video sequences. Spatial-temporal modeling involves learning the spatial features within each frame while simultaneously capturing the temporal dependencies between frames, optimizing the model's ability to predict future frames or complete missing sequences. Loss functions like mean squared error or perceptual loss may be applied to reduce discrepancies between predicted and actual frames. Adversarial training, on the other hand, may involve a generator creating video sequences and a determinator evaluating their realism, encouraging the generator to improve by minimizing the discrepancy identified by the determinator. These techniques may enable video generation models to create coherent and realistic sequences, useful in applications such as video synthesis and animation.

In audio generation models, the model training engine 306 may utilize architectures such as Audio Transformers or recurrent neural networks (RNNs), designed to handle sequential and waveform data. Audio Transformers leverage attention mechanisms to capture relationships between segments of audio, allowing them to model temporal dependencies and predict the next audio sample based on previous context. During training, the model may process large audio datasets containing diverse sound patterns to learn representations of different audio features, such as frequency, amplitude, and harmonics. This training enables the model to generate coherent audio sequences, including speech, music, or ambient sounds, by synthesizing these learned patterns.

Audio generation models may be trained using sequence modeling techniques or autoregressive methods, depending on the architecture. Sequence modeling techniques involve processing and predicting sequences of audio samples, optimizing the model to capture and reproduce temporal dependencies in sound. Autoregressive methods focus on predicting each audio sample based on prior samples, progressively refining the generated audio sequence over multiple iterations. Loss functions like mean absolute error or cross-entropy loss may be used to minimize the error between predicted and actual audio samples, guiding the model to improve its accuracy. These approaches allow audio generation models to create continuous and realistic audio outputs, applicable in areas such as speech synthesis, music generation, and sound effect creation.

The reconstruction loss ensures that the difference between the original input and the reconstructed output is minimized, guiding the decoder to generate outputs that closely resemble the input data. The second component, KL divergence loss, regularizes the latent space by ensuring that the distribution of latent variables conforms to a predefined probabilistic distribution, often a Gaussian distribution. This constraint encourages the model to learn a well-organized and smooth latent space, allowing for meaningful sampling from this space during inference. By combining these loss functions, the VAE can learn a latent space that not only captures the underlying patterns in the data but also allows for the generation of novel outputs by sampling new points from this space. During the inference phase, the trained model can sample random points from the latent space to generate new, previously unseen data instances.

In training generative AI models, the model training engine 306, which includes an optimization module 308, may implement various optimization techniques to improve model performance and efficiency. The optimization module 308 is responsible for adjusting the model's internal parameters continuously, using feedback from relevant loss functions tailored to the application (e.g., text, image, audio, or video generation). Techniques such as gradient clipping, learning rate scheduling, and mixed-precision training are applied by the optimization module 308 to stabilize and fine-tune the training process. Gradient clipping may be used to stabilize the training process, especially in transformer-based models, by capping the magnitude of gradients to prevent them from becoming excessively large. Learning rate scheduling may involve gradually increasing the learning rate during initial training phases (warm-up) and then decaying it as training progresses to fine-tune the model's parameters more effectively. Mixed-precision training, which leverages lower-precision (e.g., float16) arithmetic while retaining higher precision (e.g., float32) for specific calculations, may be used to accelerate training and reduce memory consumption, enabling the model to scale efficiently even when trained on large datasets.

In some embodiments, the model training engine 306 may implement early stopping mechanisms to prevent overfitting. Early stopping monitors the generative AI model's performance on the validation dataset, halting the training process if the performance does not improve after a specified number of iterations. This ensures that the generative AI model does not continue training on noise or irrelevant patterns, which could degrade its performance on unseen data. The model training engine 306 may also support distributed training across multiple computing nodes, allowing the system to scale its computational resources as needed. Distributed training may involve splitting the generative AI model and data across multiple machines or GPUs, where each node processes a portion of the data and updates the model in parallel. This is particularly useful for large datasets or models that require significant computational power, such as deep generative models. The model training engine 306 may synchronize the updates across the nodes using techniques like synchronous or asynchronous gradient descent.

Once the generative AI model is trained, the model training engine 306 may save the final trained generative AI model in a persistent storage location for future use. In specific embodiments, metadata such as the number of epochs, the final loss values, and values of learned parameters may be logged for model versioning and/or retraining at a later stage. In some embodiments, the model training engine 306 may also implement transfer learning, where a pre-trained model is fine-tuned on a smaller, domain-specific dataset. This may reduce the amount of time and data required to train a new model, especially in cases where the available data is limited or highly specialized. The model training engine 306 may adjust the parameters of the pre-trained model to better align with the new dataset, while preserving the learned features from the original training.

In embodiments involving LLMs, new output is generated by sampling from the model's probability distribution of tokens, conditioned on the context provided as input. Transformer-based architectures use an auto-regressive approach where the model predicts the next token in a sequence one step at a time, using previously generated tokens as input for subsequent predictions. The process starts with a prompt or an initial sequence of words, and the model iteratively generates new tokens, forming coherent sentences or paragraphs based on the learned context and language patterns. For masked-language modeling, new output may be generated by filling in masked parts of the input sequence, allowing the model to complete sentences or generate variations of the provided text. The generated output can be controlled by adjusting parameters, which influences the randomness of the token sampling, enabling the generation of diverse or deterministic responses.

In image generation models, such as those using ViTs or GANs, new output is generated by sampling from the learned distribution in the model's latent space. For GANs, the generator network creates an image by transforming random noise vectors into structured image outputs through a series of layers that learn visual features like shapes, textures, and colors. The generated image is then refined through adversarial feedback from the determinator network, which assesses the realism of the generated output. For transformer-based image models, the process may involve reconstructing images by assembling patches based on the learned dependencies between them. Input conditions, such as prompts describing desired features or specific noise vectors, guide the generation process, allowing for the creation of customized images or variations of existing visual styles. These models may also generate images based on style transfer techniques or predefined templates, synthesizing images that align with the characteristics present in the training data.

Video generation models utilize spatiotemporal dependencies to synthesize new video sequences based on the patterns learned during training. In transformer-based architectures, the model may generate video frames sequentially, predicting the next frame based on the input frames and the temporal context established by prior frames. GAN-based models, specifically designed for video synthesis, may sample noise vectors or use a sequence of frames as input, transforming these into continuous and temporally coherent video outputs through the generator network. The determinator evaluates the temporal consistency and realism of the output, ensuring the generated video mimics the motion dynamics and object interactions present in real-world video data. Such models may also use attention mechanisms to focus on critical elements within each frame and their evolution across time, facilitating realistic scene transitions and motion patterns. The generation process may include user-defined input such as initial frames, motion descriptions, or specific video attributes, providing control over the output.

Audio generation models generate new audio sequences by predicting audio samples based on learned dependencies in sequential sound data. For autoregressive models, the generation process involves producing each audio sample one at a time, conditioned on previously generated samples, allowing the model to build complex audio patterns such as speech, music, or ambient sounds. The model starts with an initial segment or a random seed and uses its learned parameters to predict and synthesize subsequent samples, constructing a continuous audio waveform. Audio Transformers, on the other hand, may use attention mechanisms to identify important temporal segments within the input audio and synthesize new output based on these learned patterns. The user can control the type of audio generated by providing parameters such as pitch, tempo, or initial sound clips, enabling the model to generate outputs tailored to specific use cases like speech synthesis, music composition, or environmental sound generation.

In some embodiments, generative AI models may also integrate multiple modalities, enabling cross-modal generation where output in one modality influences or conditions the generation in another. For example, a video generation model may use text descriptions as input, synthesizing video content that aligns with the specified narrative or visual scene described. Similarly, image generation models may generate visual representations based on audio inputs, such as generating animations synchronized to musical rhythms or speech patterns. These cross-modal systems typically involve conditional GANs or multi-modal transformers, where the model processes input from one domain (e.g., text or audio) and learns to generate output in another domain (e.g., video or image) by aligning the patterns and dependencies between the different modalities. These models may allow users to generate complex, multimodal content based on combinations of inputs, such as using textual prompts to control the visual and auditory elements of a video.

It will be understood that the embodiment of the generative AI subsystem 300 illustrated in FIG. 3 is exemplary and that other embodiments may vary. The generative AI subsystem 300, as well as its constituent elements, may vary, and modifications or alternative configurations may be implemented without departing from the broader scope of the invention. For instance, different machine learning algorithms, data sources, optimization techniques, or training methodologies may be employed depending on system requirements, application domain, and available computational resources. Furthermore, features and functionalities described in one embodiment may be combined with those of another embodiment as needed, and vice versa.

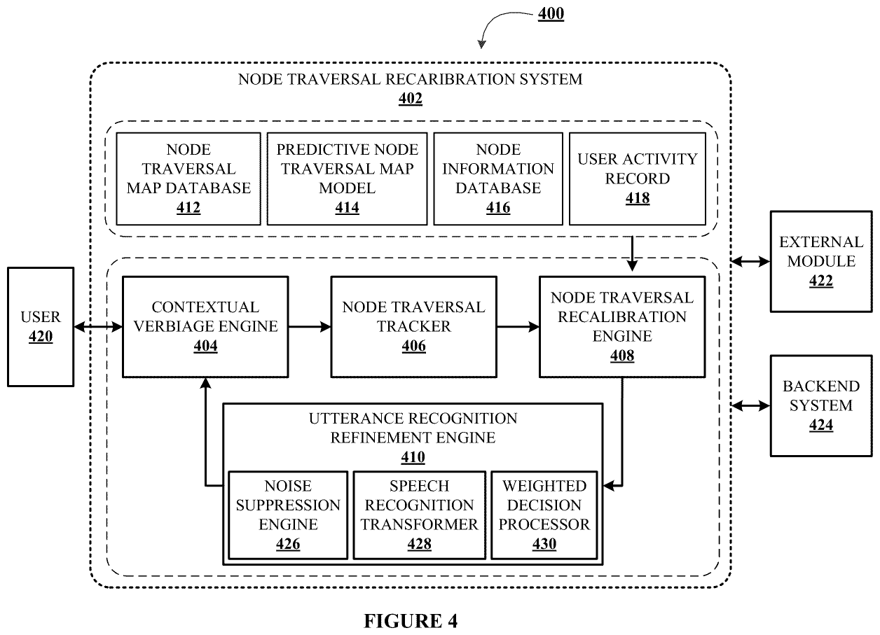

FIG. 4 illustrates an example node traversal recalibration system diagram 400 in interactive voice response (IVR) system, in accordance with an embodiment of the disclosure. The node traversal recalibration system 400 may comprise node traversal calibration system 402, user 420, and external module 422. The node traversal system 402 is a cornerstone of the system, interacting with the user 420 and executing user's intent using the corresponding external module 422 connected to the node traversal calibration system 402. The node traversal calibration system 402 may comprise engines and modules such as contextual verbiage engine 404, node traversal tracker 406, node traversal recalibration engine 408, and utterance recognition refinement engine 410. Further, the node traversal calibration system 402 may comprise supporting modules and database such as node traversal map database 412, predictive node traversal map model 414, node information database 416, and user activity record 418. The node traversal system 402 is supported by the backend system 424. The utterance recognition refinement engine may comprise noise suppression engine 426, speech recognition transformer 428, and weighted decision processor 430.

The contextual verbiage engine 404 interacts with the user 420. The contextual verbiage engine 404 may receive user input and provide prompts or information associated with the user's intent via the user device. The user input may be received through a user utterance or Dual Tone Multi-Frequency (DTMF) tone input. For example, and in some embodiments, the contextual verbiage engine 404 may use Natural Language Processing (NLP) to recognize the user utterance and identify the user's intent. Additionally, the contextual verbiage engine 404 may provide prompts to the user, such as a menu of options (e.g., “Press 1 for billing, Press 2 for technical support”, or “Speak Yes”, “Speak No”), and receive responses through the user utterance or the keypad of the user device, where each key generates a unique tone that can be identified by the contextual verbiage engine 404. These prompts may be pre-recorded audio files or generated in real time using text-to-speech (TTS) technology. In some embodiments, the contextual verbiage engine 404 may present prompts in various formats (e.g., audio, text, image, and/or video) via the user device and receive user input through various formats (e.g., audio, text, image, and/or video) via the user device. Moreover, and in some embodiments, the contextual verbiage engine 404 may integrate with other communication channels such as user communication platforms, chatbots, email, SMS, and/or the like.

Furthermore, the contextual verbiage engine 404 may receive input in a text form from users or other subsystems (e.g., the utterance recognition refinement engine 410). The text input from other subsystems may be a refined text generated by the utterance recognition refinement engine 410, wherein the refined text is based on the user utterance and is refined for noises and speech variations in the user utterance. The contextual verbiage engine 404 may be configured to generate adaptive prompts based on the refined text to interact with the user.

In some embodiments, the contextual verbiage engine 404 may incorporate machine learning and conversational AI for more natural interactions or support multiple languages. In certain embodiments, the contextual verbiage engine 404 may access past interaction data associated with the user and customize speech interactions, such as adjusting speech tone, accent, speed, and/or vocabulary, to align with the user's preferences.

As used herein, the term “user's intent” or “actual user intent” refer to the actual intent of the user, and the term “user intent” refers to an intent extracted from the user input or refined text revised from the user input at the utterance recognition refinement engine 410. The user intent may differ from the actual user intent when the user's utterance is affected by noise or when the user's speech style is unique, resulting in difficulty for the contextual verbiage engine 404 to accurately identify the actual user intent.

In some embodiments, the contextual verbiage engine 404 may be configured to identify the user intent, and determine an intent module associated with the user intent based on the user input or the refined text. Further, the contextual verbiage engine 404 may be configured to use prompts to the user 420 to request confirmation whether the identified user intent aligns with the actual user intent. The contextual verbiage engine 404 may receive the user's confirmation via the user's voice or the DTMF tone input from the user device.

In an example embodiment, the node traversal tracker 406 may be configured to determine a current node, and a node traversal map of a current call session. As used herein, the “node” in the IVR system refers to a distinct point or step in the call flow that represents a specific action, decision, or interaction with the user 420. The node may comprise information about the user intent, the intent module used to execute the user intent. The node traversal map may represent the flow of previous nodes and the current node within the current call session. In some embodiments, the node traversal tracker 406 may determine the current node and the node traversal map based on the user intent and the intent module provided by the contextual verbiage engine 404.

In an example embodiment, the node traversal recalibration engine 408 may be configured to determine whether the current node aligns with the actual user intent based on the node traversal map database 412, the predictive node traversal map model 414, the node information database 416, and the user activity record 418.

The node traversal map database 412 may comprise past node traversal map data from previous call sessions with various users including the user 420 associated with the current call session. In some embodiments, historical node data associated with the user intent may be used to determine whether the current node and the node traversal map align with the actual user intent. Furthermore, the system may retain modules visited by the user 420 during past call sessions for the same user intent. The retained modules may be completed with a minimum average handling time (AHT), wherein the minimum AHT indicates that the process was executed efficiently.

The predictive node traversal map model 414 may be configured to generate a predicted node traversal map based on the previous nodes of the current call session. The node traversal recalibration engine 408 may be configured to compare the predicted node traversal map with the current node and the node traversal map to determine whether the current node aligns with the user's intent.

The node information database 416 may comprise node rules for the business rules and channel metrics associated with the nodes. The node rules for the business rules may comprise grammar-no-match conditions and grammar rules for call landing. As used herein, the term “grammar-no-match conditions” refers to a list of specific terms or grammar structures required for each node. For example, when a node comprises a user intent of an account transfer, the grammar-no-match conditions may include the terms “account” or “transfer”. The grammar rules for call landing may comprise business processes or rules associated with individual nodes. The grammar rules may define how each node in the call flow operates, interacts with the user, and transitions to other nodes. The channel metrics may comprise the average handling time (AHT) of the nodes, the call transfer rate of the nodes to a live agent, and repeated numbers of the node traversal recalibration process for the nodes. In some embodiment, the channel metrics may serve as indicators for the node traversal recalibration engine 408 to determine that the current node is not performing effectively with the user's intent when the processing time exceeds the AHT or the call transfer rate increases significantly.

The user activity record 418 may support the node traversal recalibration engine 408 by providing user activity information. For example, the user activity records may be transactions history of the user from past interactions.

In some embodiments, the node traversal recalibration engine 408 may be configured to utilize a pre-trained model trained using supervised deep learning transformer algorithms. Such training may be directed toward identifying discrepancies and establishing a threshold to determine whether the current node and the node traversal map require recalibration. Data generated based on the user input or the refined text (e.g., the current node and the node traversal map) is compared with stored or predicted data (e.g., the node traversal map database 412, the predictive node traversal map model 414, the node information database 416, and the user activity record 418) to identify discrepancies. The node traversal recalibration engine 408, utilizing the pre-trained model, may determine that the current node requires recalibration when the discrepancy, as compared to the stored or predicted data associated with the current node and the node traversal map, exceeds the threshold. Conversely, the node traversal recalibration engine 408 may determine to retain the current node and the node traversal map when the discrepancy remains below the threshold.

In an example embodiment, the utterance recognition refinement engine 410 may be configured to receive the user utterance and process an utterance recognition refinement process to generate the refined text based on the user utterance. The utterance recognition refinement engine 410 may comprise the noise suppression engine 426, speech recognition transformer 428, and weighted decision processor 430 to perform the utterance recognition refinement process.

The noise suppression engine 426 may be configured to suppress communication or background noises in the user utterance using an AI-based noise suppression process. The AI-based noise suppression process detects the noises, classifies the noises, implements noise cancellation algorithms, and integrates deep learning models for dynamic, adaptive noise cancellation from the user utterance to generate a noise-suppressed utterance. The noise suppression engine 426 may further be configured to generate noise analysis data that comprises detected noise and classification of the noise from the user utterance.

The speech recognition transformer 428 may be configured to use an AI-based speech recognition transformer to generate a recognized text based on the noise-suppressed utterance. The AI-based speech recognition transformer may be configured to utilize and integrate an encoder and a decoder with multi-head attention, a position-wise feed-forward neural network, and a pre-trained bespoke phonetics model to process the noise-suppressed utterance. The speech recognition transformer 428 may further be configured to generate utterance analysis data that comprises detected irregularities (e.g., feature vectors comprising noise parameters) during the noise suppression process and utilize pre-trained models to recognize the user utterance.

The weighted decision processor 430 may be configured to provide a weighted decision for the recognized text to generate a refined text. The weighted decision may be based on contextual information fed into the weighted decision processor 430, wherein the contextual information may be associated with the recognized text and may comprise context data, a corpus, and node data. The context data may provide background or detailed information related to the recognized text. The corpus may provide variant examples of user utterance associated with the recognized text. The node data may provide relevant nodes associated with the recognized text. For instance, the node data may provide relevant nodes associated with the resource transfer or expected nodes during a call session when the user intends to transfer resources. The node traversal map database 412, predictive node traversal map model 414, and node information database 416 may be configured to provide and update information to the contextual information.

In an example embodiment, the user 420 interacts with the node traversal recalibration system 402 through the contextual verbiage engine 404 via a user device (e.g., phone, smartphone, and/or the like) during the call session. The user 420 may receive prompts from the contextual verbiage engine 404 and respond by speaking or transmitting DTMF tones by pressing the keypad on the user device.

In some embodiments, the user 420 may interact with the contextual verbiage engine 404 using various formats (e.g., audio, text, image, and/or video) via a user device when the contextual verbiage engine 404 is integrated with other communication channels, such as user communication platforms, chatbots, email, SMS, and/or the like.

In an example embodiment, the external module 422 may be modules or systems that resides outside of the IVR system that can be integrated or used within the IVR system. The external module 422 may provide functionality to the node traversal recalibration system 402 to process the user's intent. The external module 422 may be configured to use the application program interface (API) that may be configured to offer an API Plug-in to the IVR system, whereby the API Plug-in connects the node traversal recalibration system 402 to the external module 422 allowing the IVR system or the node traversal recalibration system 402 to utilize features of the external module 422.

In an example embodiment, the backend system 424 may comprise the infrastructure, databases, software, and services that operate behind the scenes to support the functionality of the node traversal recalibration system 402. While the node traversal recalibration system 402 interacts with the user 420 on the front end (e.g., via the contextual verbiage engine 404), the backend system 424 may process data, retrieve information, and execute other subsystems or modules associated with the node traversal recalibration system 402.

It should be noted that the description provided herein is merely one embodiment of the AI-based node traversal recalibration system and the associated components. Various modifications, alterations, and adaptations may be made without departing from the scope of the disclosure. The specific configurations, components, and functionalities described are illustrative and may be replaced or modified in other embodiments depending on the particular requirements of the AI-based node traversal recalibration system. For example, different network topologies, alternative processing units, or variations in network configurations may be used to achieve similar objectives. As such, the scope of the invention should not be limited by the described embodiment.

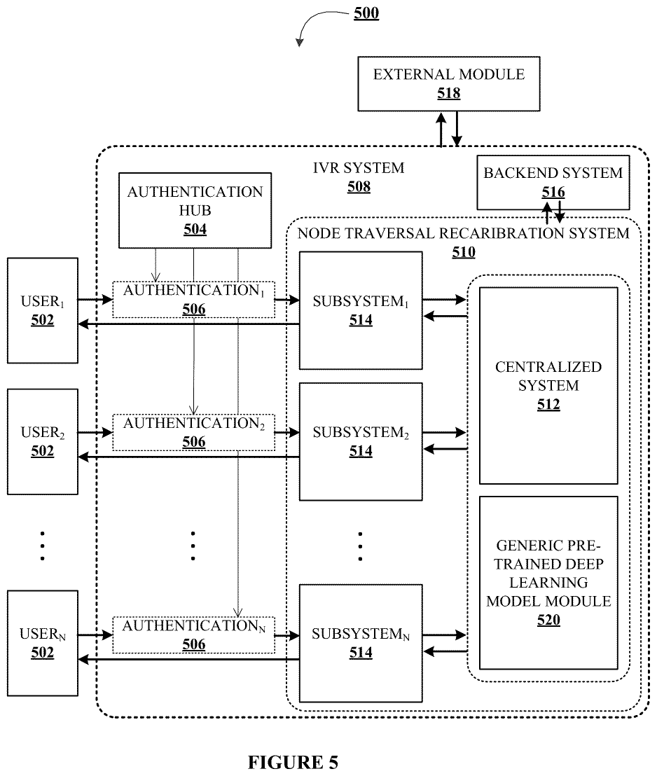

FIG. 5 illustrates an example high-level architecture diagram 500 for the AI-based node traversal recalibration system in IVR system, in accordance with an embodiment of the disclosure. The high-level architecture of the AI-based node traversal recalibration system 500 may comprise user 502, an authentication hub 504 and authentication 506 for authenticating the user 502 to the IVR system 508, the IVR system 508, and external module 518. The IVR system 508 may comprise node traversal recalibration system 510, generic pre-trained deep learning model module 520, and backend system 516. The node traversal recalibration system 510 may be configured to operate a hierarchical system that comprise a centralized system 512 and subsystem 514.

In an example embodiment, the user 502 interacts with the IVR system 508 through the subsystem 514 of the node traversal recalibration system 510 via the user device (e.g., phone, smartphone, and/or the like). Multiple users may interact with the IVR system, parallelly, at the same time. In some embodiments, the user 502 may interact with the subsystem 514 using various formats (e.g., audio, text, image, and/or video) via the user device when the node traversal recalibration system 510 is integrated with other communication channels, such as user communication platforms, chatbots, email, SMS, and/or the like.

In an example embodiment, the authentication hub 504 may be configured to authenticate the user 502 to establish interaction with the IVR system 508. The authentication process may be designed to verify identity of the user 502, ensuring secure access to sensitive information or services and preventing unauthorized access, such that only an authorized user may perform specific actions or retrieve confidential data. The authentication hub 504 may comprise database of the user 502 associated with the authentication. In some embodiments, the authentication hub 504 may be an external system outside the IVR system 508 and authorize the user 502.

The authentication hub 504 may be configured to use various authentication methods such as, Knowledge-based Authentication, Token-based Authentication, Multi-Factor Authentication, and/or the like. For instance, and in some embodiments, the user 502 may be requested to provide: answers to the security questions, PIN number, one-time password (OTP) sent via user devices, combination of multiple authentication responses, and/or the like.

In an example embodiment, the authentication 506 ensures the user 502 to interact with the IVR system 508. Each of the user 502 may require receiving authentication 506 from the authentication hub 504 to establish interaction with the IVR system 508.

In an example embodiment, the node traversal recalibration system 510 (e.g., node traversal recalibration system 402) may be configured to operate the hierarchical system that comprise the centralized system 512 and the subsystem 514 to facilitate efficient interaction with multiple users and to implement the functionalities depicted in the node traversal recalibration system diagram 400. Each subsystem 514 is operatively coupled to the centralized system 512 and is configured to receive computational resources from the centralized system 512. The subsystem 514 may be configured to manage the call session and process user requests for the authorized user authenticated by the authentication hub 504. Further, the subsystem 514 may be configured to align the user's intent by recalibrating the node traversal using the pre-trained model provided by the centralized system 512.

In an example embodiment, the centralized system 512 may be configured to operate as a central processing hub, orchestrating the allocation of computational resources to the subsystem 514 and assigning the user 502 to the subsystem 514. As used herein, and in some embodiments, the “computational resource” refers hardware, software, and system-level resources that are required to interact with the user 502 during the call session using the node traversal recalibration system 402. The computational resource may further comprise: the modules and AI-based engines, such as the contextual verbiage engine 404, the node traversal tracker 406, the node traversal recalibration engine 408, the utterance recognition refinement engine 410, the external modules 422, the backend system 424, the noise suppression engine 426, the speech recognition transformer 428, and the weighted decision processor 430; and processing inputs for node traversal recalibration process, such as the node traversal map database 412, the predictive node traversal map model 414, the node information database 416, and the user activity record 418.

In some embodiments, the centralized system 512 may be configured to use supervised deep learning transformer algorithms to train the pre-trained models for the node traversal recalibration. The supervised deep learning transformer algorithms may generate and train the pre-trained model to determine whether the current node aligns with the actual user intent. The pre-trained model may be trained using labeled input data, wherein the labeled input data comprise data from past call sessions. Each past call session comprises its own session data (e.g., nodes, node traversal map, and data used from: the node traversal map database 412, predictive node traversal map model 414, node information database 416, and user activity record 418) that can be labeled along with the outcome of the call session.

In an example embodiment, the subsystem 514 may be configured to use the computational resources allocated by the centralized system 512 to manage call session with the assigned user 502 from the centralized system 512, wherein the user 502 is authenticated by the authentication hub 504. The subsystem 514 may be configured to generate and store user interaction data during the call session with the user 502. The user interaction data may comprise user inputs, the determined current node and node traversal map, data used by the pre-trained model, the results generated by the pre-trained model, and any other data associated with the call session that is generated or used by the node traversal recalibration system. Additionally, the subsystem 514 may be configured to transmit the user interaction data to the centralized system 512. The centralized system 512 may collect all user interaction data from the subsystem 514 and utilize the collected data for training and updating the pre-trained model, whereby improving the accuracy and ensuring the pre-trained model reflects up-to-date interactions with the user 502.

In an example embodiment, the generic pre-trained deep learn model module 520 may be configured to provide foundation models to the subsystem 514 to support the AI-based engines (e.g., noise suppression engine 426, speech recognition transformer 428) in the utterance recognition refinement engine 410. The foundation models may comprise speech models, language models, footfall models, background noise models, and speech variation models. The foundation models may be re-trained using the noise analysis data collected from the noise suppression engine 426 and the utterance analysis data collected from the speech recognition transformer 428, thereby adapting the foundation models to recent trends in language usage and

### Speech Styles, and Speech Variations

In an example embodiment, the backend system 516 may comprise the infrastructure, databases, software, and services that operate behind the scenes to support the functionality of the IVR system 508 including the node traversal recalibration system 510. While the IVR system 508 interacts with the user 502 on the front end (e.g., via the subsystem 514), the backend system 516 may process data, retrieve information, and execute other subsystems or modules associated with the IVR system 508.

In an example embodiment, the external module 518 may be modules or systems that resides outside of the IVR system 508 that can be integrated or used within the IVR system 508. The external module 518 may provide functionality to the subsystem 514 to process the user's intent. The external module 518 may be configured to use the application program interface (API) that may be configured to offer an API Plug-in to the IVR system 508, whereby the API Plug-in connects the node traversal recalibration system 510 to the external module 422 allowing the IVR system 508 and the node traversal recalibration system 510 to utilize features of the external module 518.

It should be noted that the description provided herein is merely one embodiment of the high-level architecture of the AI-based node traversal recalibration system and the associated components. Various modifications, alterations, and adaptations may be made without departing from the scope of the disclosure. The specific configurations, components, and functionalities described are illustrative and may be replaced or modified in other embodiments depending on the particular requirements of the high-level architecture of the AI-based node traversal recalibration system. For example, different network topologies, alternative processing units, or variations in network configurations may be used to achieve similar objectives. As such, the scope of the invention should not be limited by the described embodiment.

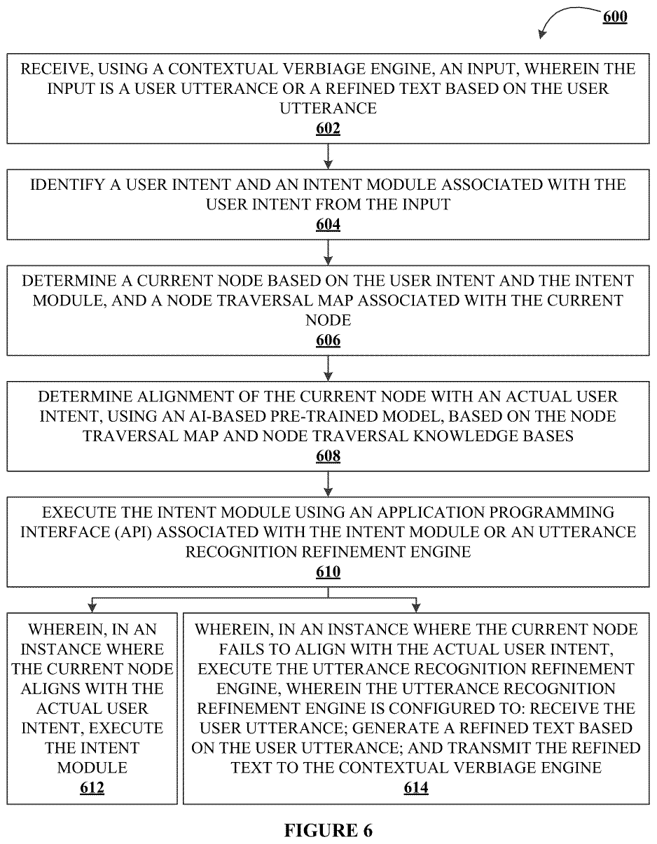

FIG. 6 illustrates a process flow 600 for recalibrating the node traversal in the IVR system using the AI-based engines, in accordance with an embodiment of the disclosure.

As shown in block 602, the process flow 600 may include the step of receiving, using a contextual verbiage engine, an input, wherein the input is a user utterance or refined text based on the user utterance. For example, and in some embodiments, the contextual verbiage engine 404 may receive a user input via the user device during a call session. The user input may be either a user utterance or DTMF tone inputs, wherein the user input is the response to the prompt generated by the contextual verbiage engine 404 from the user.

In some embodiments, the contextual verbiage engine 404 may receive the refined text from the utterance recognition refinement engine 410 and generate. The refined text is generated by the utterance recognition refinement engine 410 based on the user utterance when the node traversal recalibration system determines that the current node fails to align with the actual user intent. The utterance recognition refinement engine 410 may suppress communication noise or background noise in the user utterance and compensate for speech characteristics that deviate from speech clarity. Furthermore, the utterance recognition refinement engine 410 may convert the processed user utterance into text form, thereby generating the refined text and transmitting the refined text to the contextual verbiage engine 404. A detailed description of the utterance recognition refinement engine 410 is provided below.

In some embodiments, the contextual verbiage engine 404 may generate and transfer prompts to the user and receive responses through either the user utterance or the keypad of the user device, where each key generates a unique tone that can be identified by the contextual verbiage engine 404. For instance, the contextual verbiage engine 404 may transmit prompts to the user with menu options, such as: “Say ‘Yes’ to speak with an agent; Speak ‘No’ to continue the call,” or “Press 1 for billing; Press 2 for technical support.” The prompts may be pre-recorded audio files or generated in real time using text-to-speech (TTS) technology. In some embodiments, the contextual verbiage engine 404 may present prompts in various formats (e.g., audio, text, image, and/or video) via the user device and receive user input through various formats (e.g., audio, text, image, and/or video) via the user device. Moreover, and in some embodiments, the contextual verbiage engine 404 may integrate with other communication channels such as user communication platforms, chatbots, email, SMS, and/or the like.

In some embodiments, the contextual verbiage engine 404 may generate and transfer prompts based on the refined text. The prompts may be generated to receive confirmation from the user via the user device whether the content of the refined text aligns with the actual user intent. In certain embodiments, the contextual verbiage engine 404 may be configured to generate the prompt to request the user to enhance the quality of the user utterance. For instance, the prompt may instruct the user to relocate to a quieter location to reduce background noise interrupting the user utterance or to disconnect and reconnect the call session to improve communication quality.

As shown in block 604, the process flow 600 may include the step of identifying a user intent and an intent module associated with the user intent from the input. For example, and in some embodiments, the contextual verbiage engine 404 may use Natural Language Processing (NLP) on the user utterance to comprehend the intent and context behind the user's input. Subsequently, the contextual verbiage engine 404 may generate the user intent based on the results of the NLP and determine the intent module that executes the user intent. Similarly, the contextual verbiage engine 404 may use NLP on the refined text to generate the user intent and determine the intent module that executes the user intent.

For instance, the contextual verbiage engine 404 may identify the user intent from the user utterance as “make an account.” The contextual verbiage engine 404 determines the intent module related to opening the account. In subsequent steps, the node traversal recalibration system may determine that the user intent does not align with the actual user intent. In such a case, the user utterance is sent to the utterance recognition refinement engine 410 to revise the user utterance, generating the refined text. Then, the contextual verbiage engine 404 identifies that the user intent is “transfer account” based on the refined text, and determine the intent module related to transferring the account.

As shown in block 606, the process flow 600 may include the step of determining a current node based on the user intent and the intent module, and a node traversal map associated with the current node. For example, the node, comprising information about the user intent and the intent module that is used to execute the user intent, may be generated. Additionally, the node traversal map may be generated with the previous nodes and the current node within the current call session and comprises the flow of the nodes. In some embodiments, the node traversal tracker 406 may determine the current node and the node traversal map based on the user intent and the intent module provided by the contextual verbiage engine 404.

As shown in block 608, the process flow 600 may include the step of determining alignment of the current node with an actual user intent, using an AI-based pre-trained model, based on the node traversal map and node traversal knowledge bases. For example, and in some embodiments, the node traversal recalibration system may be configured to utilize an AI-based pre-trained model trained by supervised deep learning transformer algorithms. Such training may be directed toward identifying discrepancies and establishing a threshold to determine whether the current node and the node traversal map require recalibration. In some embodiments, the node traversal knowledge bases may comprise the node traversal map database 412, the predictive node traversal map model 414, a node information database 416, and at least one of user activity record 418 associated with the user.

In some embodiments, the node traversal recalibration engine 408 may compare data generated based on the user input or the refined text (e.g., the current node and the node traversal map) with the stored or predicted data (e.g., the node traversal map database 412, the predictive node traversal map model 414, the node information database 416, and the user activity record 418) to identify discrepancies. The node traversal recalibration engine 408, utilizing the AI-based pre-trained model, may determine that the current node requires recalibration when the discrepancy, as compared to the stored or predicted data associated with the current node and the node traversal map, exceeds the threshold. Conversely, the node traversal recalibration engine 408 may determine to retain the current node and the node traversal map when the discrepancy remains below the threshold.

For instance, and in some embodiments, the node traversal recalibration engine 408 may determine that the current node fails to align with the actual user intent in the following example cases: when the node traversal map fails to match or partially match a case stored in the node traversal map database 416 that shares the same intent as the user intent; when the node traversal map fails to follow or partially follow the predictive node traversal map model 414; when the current node fails to match or partially match the node information database 416 (e.g., required keywords not identified in the user current node according to the grammar-no-match conditions, or the current node does not comply with the grammar rules for the call landing, and/or the like); or the user activity record 418 fails to support the current node. In some embodiments, threshold of the discrepancy between the current node or the node traversal map and the stored or predicted data may be determined by how the partially matching condition affects the results of aligning the user intent with the actual user intent for each example case. Moreover, the combination of discrepancies from each example case may affect the threshold.

In some embodiments, the centralized system 512 of the node traversal recalibration system that utilize the hierarchical system may use the supervised deep learning transformer algorithm to set precise thresholds using the labeled and extensive data from the past call sessions with the users. The supervised deep learning transformer algorithm generates and train the AI-based pre-trained model for the node traversal recalibration engine 408 used by the subsystem 514.

As shown in block 610 and 612, the process flow 600 may include the step of executing the intent module using an application programming interface (API) associated with the intent module or an utterance recognition refinement engine, wherein, in an instance where the current node aligns with the actual user intent, executing the intent module. For example, and in some embodiments, the node traversal recalibration engine 408 may determine that the current node aligns with the actual user intent, whereby indicating that the user intent matches the actual user intent. Consequently, executing the intent module associated with the current node corresponds to executing the actual user intent. The node traversal recalibration system may use the backend system 424 to execute the intent module when the backend system 424 incorporates the intent module. Alternatively, the node traversal recalibration system may use the API plug-in provided by the intent module to execute the user intent when the intent module is an external module 422.

As shown in block 610 and 614, the process flow 600 may include the step of executing the intent module using an API associated with the intent module or an utterance recognition refinement engine, wherein, in an instance where the current node fails to align with the actual user intent, executing the utterance recognition refinement engine, wherein the utterance recognition refinement engine is configured to: receive the user utterance; generate the refined text based on the user utterance; and transmit the refined text to the contextual verbiage engine. For example, and in some embodiments, the node traversal recalibration engine 408 may determine that the current node fails to align with the actual user intent, whereby indicating that the user intent fails to match the actual user intent. Thus, the node traversal recalibration system may use the utterance recognition refinement engine 410 to revise the user utterance and convert the processed user utterance into text form, thereby creating the refined text. The utterance recognition refinement engine 410 is configured to suppress communication noise or background noise in the user utterance using the noise suppression engine 426 and compensate for any speech characteristics that deviate from speech clarity using the speech recognition transformer 428 to generate the recognized text followed by generating the refined text from the recognized text using the weighted decision processor 430. Then, the refined text may be sent back to the contextual verbiage engine 404, repeating the process flow 600 starting from the step 602.

In some embodiments, the node traversal recalibration system may repeat the recalibration process multiple times until the current node aligns with the actual user intent. In certain embodiments, the node traversal recalibration system may route the user to a live agent when the repetition of a node traversal recalibration process for the current node exceeds a predefined number.

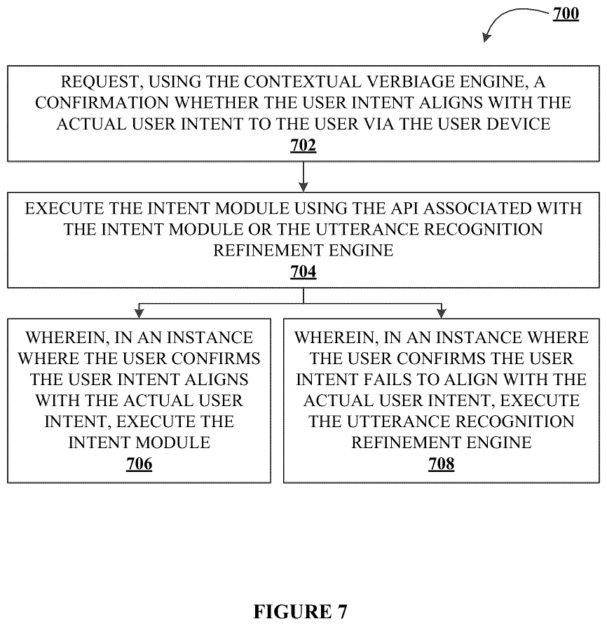

FIG. 7 illustrates a process flow 700 for requesting confirmation from the user regarding the current node, in accordance with an embodiment of the disclosure. As shown in block 702, the process flow 700 may include the step of requesting, using the contextual verbiage engine 404, a confirmation whether the user intent aligns with the actual user intent to the user via the user device. For example, and in some embodiments, the contextual verbiage engine 404 may be configured to prompt the user to confirm whether the identified user intent aligns with the actual user intent. The user may respond back to the contextual verbiage engine 404 with user utterance or Dual Tone Multi-Frequency tone inputs via the user device.

In some embodiments, the contextual verbiage engine 404 may present confirmation prompts in various formats (e.g., audio, text, image, and/or video) via the user device and receive the user response through various formats (e.g., audio, text, image, and/or video) via the user device.

As shown in block 704 and 706, the process flow 700 may include the step of execute the intent module using the API associated with the intent module or the utterance recognition refinement engine, wherein, in an instance where the user confirms the user intent aligns with the actual user intent, execute the intent module. For example, in some embodiments, the node traversal recalibration system may be configured to execute the intent module when the user confirms the identified user intent aligns with the actual user intent. The node traversal recalibration system may use the backend system 424 to execute the intent module when the backend system 424 incorporates the intent module. Alternatively, the node traversal recalibration system may use the API plug-in provided by the intent module to execute the user intent when the intent module is an external module 422.

As shown in block 704 and 708, the process flow 700 may include the step of executing the intent module using the API associated with the intent module or the utterance recognition refinement engine, wherein, in an instance where the user confirms the user intent fails to align with the actual user intent, execute the utterance recognition refinement engine. For example, and in some embodiments, the node traversal recalibration system may be configured to execute the utterance recognition refinement engine 410 by transferring the user utterance when the user confirms the user intent fails to align with the actual user intent. The utterance recognition refinement engine 410 may revise the user utterance using noise suppression engine 426, speech recognition transformer 428, and weighted decision processor 430 to generate the refined text. Then, the refined text may be transferred back to the contextual verbiage engine 404 to repeat the node traversal recalibration process described in the process flow 600 or the contextual verbiage engine 404 may generate the prompt based on the content of the refined text to receive confirmation that the refined text aligns with the actual user intent.

In some embodiments, the node traversal recalibration system may request the user to repeat the user utterance using the contextual verbiage engine 404 when the user confirms that the user intent fails to align with the actual user intent. The node traversal recalibration system may then use the updated user utterance to identify the actual user intent. Furthermore, the contextual verbiage engine 404 may transmit a request to the user to enhance the quality of the user utterance before repeating the user utterance. For instance, the request may ask the user to relocate to a quieter place to reduce background noise interfering with the user utterance or to disconnect and reconnect the call session to improve communication quality and then repeat the user utterance.

In some embodiments, the node traversal recalibration system may repeat the requesting confirmation process to the user multiple times until the current node aligns with the actual user intent. In certain embodiments, the node traversal recalibration system may route the user to a live agent when the repetition of the requesting confirmation process exceeds a predefined number.

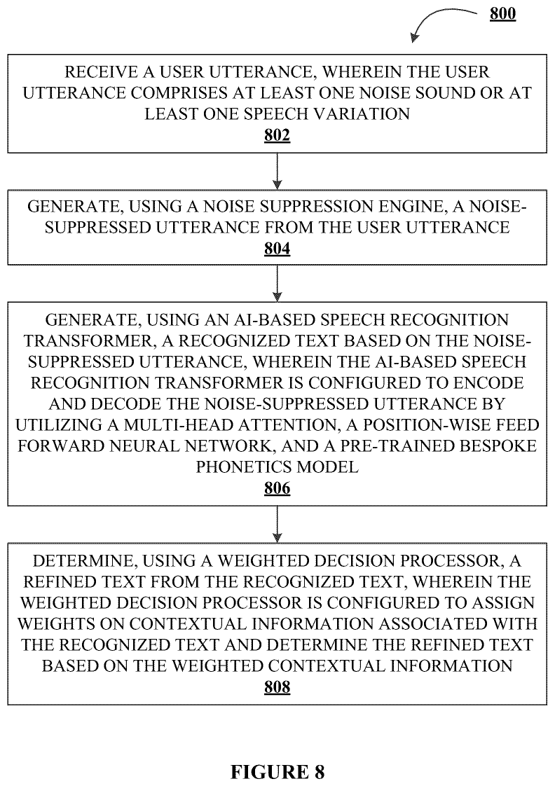

FIG. 8 illustrates a process flow 800 for recognizing the user utterance using the AI engines, in accordance with an embodiment of the disclosure. As shown in block 802, the process flow 800 may include the step of receiving a user utterance, wherein the user utterance comprises at least one noise sound or a speech variation. For example, and in some embodiments, the node traversal recalibration system 402 may transfer the user utterance to the utterance recognition refinement engine 410 in instances where the node traversal recalibration system 402 determines the user intent from the current node fails to align with the actual user intent. In some embodiments, the utterance recognition refinement engine 410 may process the user utterance using AI-based speech recognition systems to identify the actual user intent to recalibrate the node traversal of the call session.

In some cases, the user utterance may comprise background noise (e.g., surrounding sounds introduced during the call session) or may be interrupted by communicational noise (e.g., echo, static, distortion in audio communication, and/or the like). Such noises may result in the false identification of the actual user intent by the contextual verbiage engine 404. Moreover, the user utterance may comprise speech variations that deviate from the speech clarity. The speech variation in the user utterance may also cause the contextual verbiage engine 404 to fail to identify the actual user intent.

In some embodiments, the utterance recognition refinement engine 410 may be configured to utilize the noise suppression engine 426 to suppress the background noise or the communicational noise in the user utterance. Further, the utterance recognition refinement engine 410 may be configured to utilize the speech recognition transformer 428 and the weighted decision processor 430 to the user utterance comprising the speech variations to identify the actual user intent.

As shown in block 804, the process flow 800 may include the step of generating, using a noise suppression engine, a noise-suppressed utterance from the user utterance. For example, and in some embodiments, the noise suppression engine 426 may be configured to utilizes the AI-based noise suppression process that operates adaptive noise cancellation. The noise suppression engine 426 may be configured to detect and classify the noises, implements noises cancellation algorithms, and integrates deep learning models to suppress the noises from the user utterance generating the noise-suppressed utterance. A detailed description of the AI-based noise suppression process is provided below.

As shown in block 806, the process flow 800 may include the step of generating, using an AI-based speech recognition transformer, a recognized text based on the noise-suppressed utterance, wherein the AI-based speech recognition transformer is configured to encode and decode the noise-suppressed utterance by utilizing a multi-head attention, a position-wise feed forward neural network, and a pre-trained bespoke phonetics model. For example, and in some embodiment, the speech recognition transformer 428 may be configured to utilize the transformer model to generate the recognized text based on the noise-suppressed utterance.

In some embodiments, the transformer model (e.g., speech recognition transformer 428) processes an input speech signal (e.g., the noise-suppressed utterance) and converts the noise-suppressed utterance to a text transcript (e.g., recognized text) by utilizing an encoder and a decoder to encode and decode using the multi-head attention, the position-wise feed forward neural network, and the pre-trained bespoke phonetics model.

The noise-suppressed utterance is first preprocessed to extract relevant acoustic features (e.g., Mel spectrograms) that convert the audio signal into a time-frequency representation and Mel-Frequency Cepstral Coefficients (MFCCs) that capture key speech features relevant for the speech recognition. The encoder transforms the acoustic features into tokens which is smallest units of data that the transformer model processes and maps to an embedding vector which is a mathematical representation of data that uses numbers to capture the meaning and relationships of mapped tokens. The encoder may add positional encoding to the embeddings to maintain temporal information (i.e., the sequence of sounds in time). Then the encoder is configured to use the multi-head attention that applies multiple attention heads in parallel. Each head focuses on a different aspect or representation of the tokens, enabling the transformer model to capture more comprehensive contextual information. The multi-head attention enables the transformer model to recognize dependencies in the noise-suppressed utterance, such as phoneme transitions or coarticulations. Further, the encoder is configured to process each token to pass through the position-wise feed forward neural network to updated with information from other tokens, refining the representations of the tokens for each token. The output of the encoding process produces a series of contextualized embeddings representing the noise-suppressed utterance.

The pre-trained bespoke phonetics model processes the output of the encoder to generate a phoneme-level or phonetic representation, thereby bridging the gap between acoustic features and textual output to support the decoder. The pre-trained bespoke phonetics model introduces an intermediate representation between the encoder and decoder, focusing on phonemes or phonetic features to enhance linguistic accuracy.

The decoder converts the encoded representations or phonetic features into a sequence of textual tokens. The decoder first processes previously generated tokens (e.g., partial transcription) using masked multi-head attention to predict the next token. Masking prevents future tokens from influencing current token predictions, ensuring autoregressive generation. Next, the decoder utilizes a cross-attention (e.g., encoder-decoder attention) to focus on relevant parts of the encoder outputs with phonetic representations for each token. Then, the decoder is configured to process each token to pass through the position-wise feed forward neural network to refine each token's embeddings after the cross-attention. The output of the decoding process produces predicts of the next token in the sequence representing the transcribed text, such as a character, word, or subword, until the end of the sequence is reached. Finally, the transformer model (e.g., speech recognition transformer 428) generates the recognized text by merging tokens into coherent text.

As shown in block 808, the process flow 800 may include the step of determining, using a weighted decision processor, a refined text from the recognized text, wherein the weighted decision processor is configured to assign weights on contextual information associated with the recognized text and determine the refined text based on the weighted contextual information. For example, and in some embodiments, the weighted decision processor 430 may be configured to receive the recognized text and generate the refined text based on the weighted contextual information. The contextual information may provide additional foundation data for the weighted decision processor 430 to determine the refined text. The weighted decision processor 430 may be configured to assign weights to contextual information sources to control the effectiveness of each contextual information source.

In some embodiments, the contextual information may comprise context data, a corpus, and node data associated with the recognized text. The context data may provide background or detailed information related to the recognized text. The corpus may offer various examples of written text associated with the content of the recognized text. For example, the corpus may present variations of written texts for resource transfer when the recognized text pertains to transferring resources. The node data may provide relevant nodes linked to the recognized text. For instance, the node data may specify nodes related to the resource transfer or expected nodes, such as inquiries about which account to transfer resources from and to, or the number of resources to transfer, when the recognized text pertains to transferring resources.

In some embodiments, the weighted decision processor 430 may assign weights to contextual information sources to control the influence of each source. For example, and in some embodiments, the weighted decision processor 430 may be configured to emphasize the influence of node data by assigning a weight of 60% to the node data, while assigning weights of 20% each to the context data and the corpus. The output of the weighted decision processor 430 (e.g., the refined text) is primarily determined by the node data, while the remaining text is refined using the context data and the corpus.

In some embodiments, the refined text may be transferred to the contextual verbiage engine 404 for interaction with the user based on the refined text. The refined text may include the user intent, and the contextual verbiage engine 404 may be configured to identify the user intent. The contextual verbiage engine 404 may send a confirmation prompt to the user via the user device to verify that the refined text aligns with the user's actual intent. The node traversal recalibration system 402 may be configured to proceed with the next process if the user confirms that the user intent derived from the refined text aligns with their actual intent.

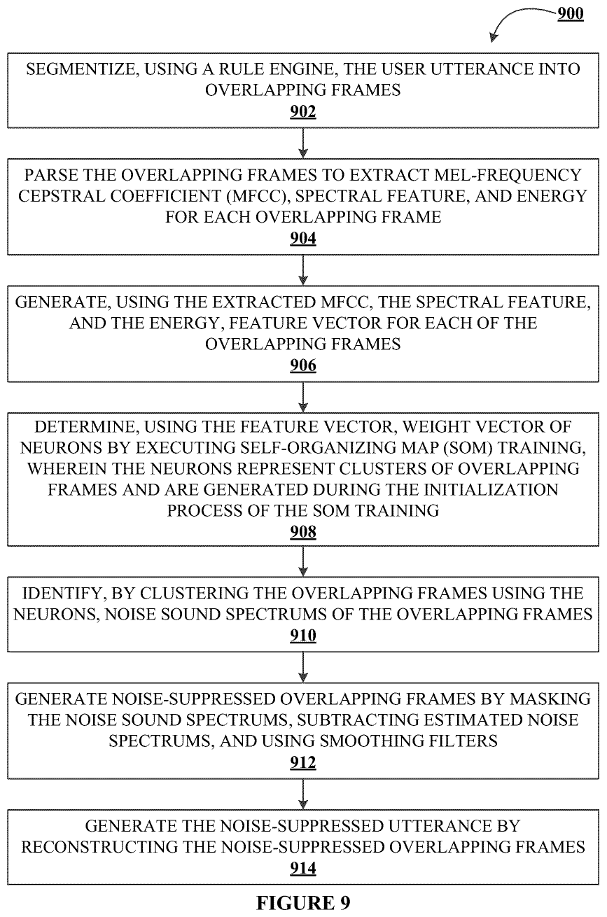

FIG. 9 illustrates a process flow 900 for suppressing the noise in the user utterance using the AI engines, in accordance with an embodiment of the disclosure.

As shown in block 902, the process flow 900 may include the step of segmentizing, using a rule engine, the user utterance into overlapping frames. For example, and in some embodiments, the noise suppression engine 426 may be configured to divide the user utterance into short, overlapping frames. The rule engine may be configured to determine the frame size (e.g., period of the frame) and the hop size (e.g., period of overlap) based on the period of the user utterance or the noise level.

In some embodiments, the segmentizing process may commence by normalizing the user utterance to ensure consistency in amplitude. Subsequently, the normalized user utterance may be segmentized using a predetermined frame size and hop size by the rule engine. Typical parameters for the frame size range from 20 to 40 milliseconds (e.g., 25 milliseconds for speech processing), while the hop size typically ranges from 50% to 70% of the frame size (e.g., a 10-millisecond hop for a 25-millisecond frame). The rule engine may determine the frame size outside of the typical frame size range, depending on the user utterance. The overlapping of frames may facilitate smooth transitions between frames and enable the capture of transient details.

As shown in block 904, the process flow 900 may include the step of parsing the overlapping frames to extract Mel-Frequency Cepstral Coefficient (MFCC), spectral feature, and energy for each overlapping frame. For example, and in some embodiments, each overlapping frame may be processed to extract MFCC, spectral features, and energy. The extracted information may represent the features of the overlapping frame, that are used as input features for a subsequent processing step.

The MFCC captures the spectral envelope of the overlapping frames, which constitutes a key characteristic for distinguishing among various sound types. This feature facilitates the identification of patterns in the frequency domain, enabling the differentiation of noise from speech or other auditory signals (e.g., noises). The spectral features encompass parameters such as spectral centroid, bandwidth, and spectral roll-off. The spectral features provide insights into the frequency content and temporal variations, thereby supporting to distinguish different types of sounds, such as user's speech and the background sound. Energy quantifies the amplitude or loudness of the user utterance to identify the presence of loud noises, such as the a car honk, and/or the like.

As shown in block 906, the process flow 900 may include the step of generating, using the extracted MFCC, the spectral feature, and the energy, feature vector for each of the overlapping frames. For example, and in some embodiments, the feature vector is a collection of values (e.g., the MFCC, the spectral feature, and the energy) that describe various properties of the overlapping frames to facilitate the noise suppression engine 426 to identify and classify the noise sounds in the overlapping frame.

In some embodiments, the dimension of the feature vector depends on the number of values collected from the MFCC, the spectral feature, and the energy. For example, the noise suppression engine 426 may be configured to collect 13 MFCC samples, 3 spectral feature samples, and 1 energy value for generating the feature vector from the each overlapping frame. In this example case, the dimension of the feature vector is 17, representing sound properties of the overlapping frames.

As shown in block 908, the process flow 900 may include the step of determining using the feature vector, weight vector of neurons by executing Self-Organizing Map (SOM) training, wherein the neurons represent clusters of overlapping frames and are generated during the initialization process of the SOM training. For example, and in some embodiments, the neurons and the weight vectors may be generated during the initialization stage of the SOM training, that facilitates the clustering process of noise sound and speech sounds within the overlapping frames. Each neuron comprises the weight vector that is updated as the SOM training progresses.

In some embodiments, the noise suppression engine 426 may be configured to initialize two-dimensional grids of neurons, where the neurons represent clusters of overlapping frames that share similar feature vector values. The weight vectors are assigned to have the same dimensionality as the feature vectors, and initial values of the weight vectors may be randomly selected within the range of the input data (e.g., the value range of the feature vectors). Then, the SOM training is commenced by randomly selecting the feature vector, followed by calculating a best matching unit (BMU) with the weight vector of the neuron, wherein the BMU is the neuron whose weight vector is closest to the selected feature vector in terms of a defined distance metric. The BMU represents the neuron that “best matches” the current input data (e.g., selected feature vector). Subsequently, weight vectors are updated to adapt to the selected feature vector by adjusting the weight vector of the BMU and BMU's neighboring neurons using a weight update equation. This step is repeated iteratively, and as the SOM training progresses, the weight vectors of the neurons converge to represent clusters of similar input data (e.g., the feature vector). Additionally, the neighborhood radius of the BMU shrinks, thereby fine-tuning the organization of the map. The SOM training continues this process until the SOM stabilizes, resulting in the weight vectors of the neurons being determined.

In some embodiments, the noise suppression engine 426 may be configured to include noise audio samples to the selected feature vector during the SOM training process to generates the neurons corresponding to the noise audio samples. The weight vector of the neurons corresponding to the noise audio samples may converge to the feature vectors of the noise audio samples. The neurons corresponding to the noise audio samples may be used to identify and classify the noise in the user utterance.

As shown in block 910, the process flow 900 may include the step of identifying, by clustering the overlapping frames to the neurons, noise sound spectrums in the overlapping frames. For example, and in some embodiments, the feature vectors are clustered with the neuron whose weight vector represents specific spectral feature. Because the neurons represent specific spectral features, and the feature vectors are extracted from the overlapping frames, the clustered feature vectors correspond to clustered overlapping frames, that the clustered overlapping frames can be inferred to exhibit similar spectral characteristics.

In some embodiments, the noise suppression engine 426 may be configured to map all the feature vectors of the overlapping frames to the BMU (e.g., the neuron with the weight vector that is minimal distance with the feature vector). The overlapping frames that are clustered with the same neurons comprise similar spectral characteristics as the neurons represent clusters of similar audio frames.

For example, and in some embodiments, the noise suppression engine 426 may be configured to generate and utilize the 2 dimensional neurons grids with 3 by 3 size. A neuron N1 may represent clean speech frames, a neuron N2 may represent high-frequency noise, a neuron N3 may represent static noise, a neuron N4 may represent hybrid frame with a mix of noise and clean speech, a neuron N5 may represent silence, a neuron N6 may represent hybrid frame with a mix of silence and low-frequency noise, and/or the like. The neurons may represent specific noise sounds when the noise audio samples are used during the SOM training, such as a neuron N7 representing a car honk, a neuron N8 representing hybrid frame with clean speech and chatter, a neuron N9 representing hybrid frame with static noise and clean speech, and/or the like. Subsequently, the overlapping frames clustered to neuron N1 may be classified as clean speech frames; overlapping frames clustered to neurons N2, N3, and N7 may be classified as noise frames; and the overlapping frames clustered to neurons N4, N8, and N9 may be classified as hybrid frames containing partial noise sound. The overlapping frames clustered to neurons N7, N8, and N9 may be classified distinctly, as neurons N7, N8, and N9 are derived from the known noise samples.

As shown in block 912, the process flow 900 may include the step of generating noise-suppressed overlapping frames by masking the noise sound spectrums, subtracting estimated noise spectrums, and using smoothing filters. For example, and in some embodiments, the noise suppression engine 426 may be configured to suppress the noise spectrums in the overlapping frames by applying masking and filtering methods to each overlapping frames depending on the clustered neurons to generate the noise-suppressed overlapping frames.

In some embodiments, masking the overlapping frames attenuates or eliminates the noise by attenuating or removing the noise spectrums in the frequency domain or by increasing the amplitude of the overlapping frames that are clustered to the neuron comprising the clean speech. A spectral subtraction may be utilized to the overlapping frames clustered into the neurons with hybrid frames that comprise clean speech spectrums and the noise spectrums. Such a spectral subtraction estimates the noise spectrums in the frames and subtracts only the estimated noise spectrums to preserve the clean speech spectrums. The smoothing filters may reduce any artifacts introduced by the noise suppression process to the overlapping frames.

In some embodiments, parameters for masking, spectral subtraction, or filtering may be provided for the overlapping frames clustered to the neurons that are generated from the noise audio samples, as the noise audio samples are well-known samples with recognized spectra.

As shown in block 914, the process flow 900 may include the step of generating the noise-suppressed utterance by reconstructing the noise-suppressed overlapping frames. For example, and in some embodiments, the noise suppression engine 426 may be configured to use an overlap-add method and post-processing techniques to reconstruct the noise-suppressed utterance.

In some embodiments, the overlap-add method may be initiated by inverse-transforming the noise-suppressed overlapping frames into the time domain. Then, each overlapping frame is placed in its original position on the time axis, with overlapping segments aligned. In the overlap regions, the amplitude values of the overlapping frames are added, followed by the application of a window function to ensure smooth transitions and avoid discontinuities. Subsequently, the sum of the windowed amplitudes in the overlap regions may be normalized to 1 to prevent amplification or attenuation.

In some embodiments, the noise suppression engine 426 may be configured to apply post-processing techniques to the reconstructed user utterance. The post-processing techniques may comprise: applying spectral smoothing to reduce artifacts, such as sharp edges or discontinuities introduced during the overlap-add method; applying gain normalization to address inconsistencies in the amplitude of the reconstructed user utterance resulting from noise suppression or the overlapping frames; applying noise filtering to suppress residual noise in the reconstructed user utterance; and refining pitch and formants to enhance the naturalness of the reconstructed user utterance. Consequently, the post-processing techniques ensures generation of high-quality noise-suppressed utterance.

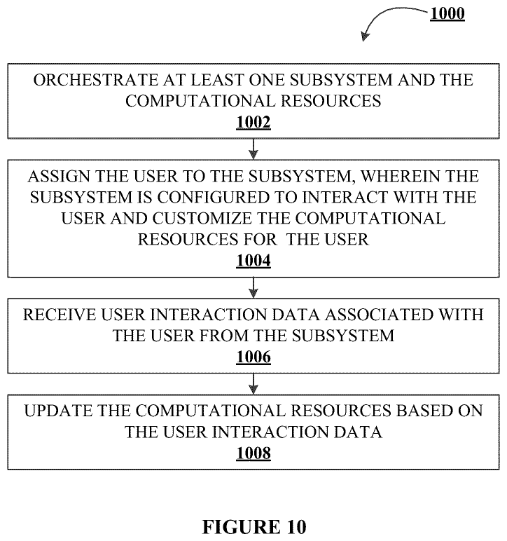

FIG. 10 illustrates a process flow 1000 for operating a hierarchical system in the node traversal recalibration system and the utterance recognition refinement system, in accordance with an embodiment of the disclosure. As shown in block 1002, the process flow 1000 may include the step of orchestrating at least one subsystem and the computational resources. For example, and in some embodiments, the node traversal recalibration system may operate the hierarchical system that comprises the centralized system 512, the subsystem 514 and the generic pre-trained deep learning model module 520, as depicted in the example high-level architecture diagram 500. The centralized system 512 may be configured to operate as a central processing hub, orchestrating the allocation of computational resources to the subsystem 514. The generic pre-trained deep learning model module 520 may be configured to provide a foundation model to the subsystem 514 to support the utterance recognition refinement engine 410.

In some embodiments, the computational resources comprise hardware, software, and system-level resources required to interact with the user. The computational resources may further comprise: the modules and AI-based engines, such as the contextual verbiage engine 404, the node traversal tracker 406, the node traversal recalibration engine 408, the utterance recognition refinement engine 410, the external modules 422, the backend system 424, the noise suppression engine 426, the speech recognition transformer 428, and the weighted decision processor 430; and processing inputs for node traversal recalibration process, such as the node traversal map database 412, the predictive node traversal map model 414, the node information database 416, and the user activity record 418.

In some embodiments, the foundation model supports the utterance recognition refinement engine 410 used by the subsystem 514. The foundation model may comprise background noise models, speech models, language models, speech variation models, and footfall models. The background noise models may support the noise suppression engine 426, proving noise features to SOM training, identification and classification of the noise in the user utterance and parameters for masking, spectrum subtraction, smoothing filters, and post-processing techniques. The speech models may comprise information bases for regional variations in speech patterns. The language models may comprise information bases for multiple languages, and the speech variation model may comprise information bases for other deviations affecting the speech clarity. The speech models, language models, speech variation models, and the footfall model (e.g., the node traversal map data) may support the speech recognition transformer 428 (e.g., the pre-trained bespoke phonetics model) and the weighted decision processor 430 (e.g., the context data, corpus, and node data).

In some embodiments, the node traversal recalibration system may be configured to manage multiple call sessions with multiple users simultaneously. The centralized system 512 may assign each user to a separate subsystem that manages each call session. The centralized system 512 orchestrates the computational resources and the generic pre-trained deep learning model module 520 to ensure efficient resource utilization while multiple subsystems operate in parallel.

As shown in block 1004, the process flow 1000 may include the step of assigning the user to the subsystem, wherein the subsystem is configured to customize the computational resources to the user. For example, and in some embodiments, the node traversal recalibration system may be configured to use the centralized system 512 to assign the user to the subsystem 514 to interact with the user. The subsystem 514 may be configured to customize the allocated computational resources for the user to enhance interaction with the user (e.g., customizing the contextual verbiage engine 404 and the utterance recognition refinement engine 410 to better focus on the user's unique speech patterns, or preparing frequently used computational resources that the user has used in the past call session) and to access the database associated with the user (e.g., accessing the node traversal map database 414 to search past node traversal maps with the same intent or accessing the user activity record 418 for transaction history).

As shown in block 1006, the process flow 1000 may include the step of receiving user interaction data associated with the user from the subsystem. For example, and in some embodiments, the subsystem 514 may be configured to store user interaction data during the call session. The user interaction data may comprise the user inputs, the determined current node and node traversal map, data used by the AI-based pre-trained model, results determined by the AI-based pre-trained model, and any other data associated with the call session that is generated or used by the node traversal recalibration system. Moreover, the subsystem 514 may be configured to transmit the user interaction data to the centralized system 512.

In some embodiments, the centralized system 512 may receive user interaction data from the subsystems for every call session and store the call session in a user interaction data database. The user interaction data database may comprise the database of various situations associated with the user intents and the user's speech patterns.

In some embodiments, the subsystem 514 may be configured to collect and transfer, to the centralized system 512, the noise analysis data and the utterance analysis data associated with the user during the call session from the utterance recognition refinement engine 410. The noise analysis data may comprise the identified and classified noise in the user utterance and parameters used for masking, spectrum subtraction, smoothing filters, and post-processing techniques. The utterance analysis data may comprise user-specific speech variations recognized during processing by the speech recognition transformer 428.

As shown in block 1008, the process flow 1000 may include the step of updating the computational resources based on the user interaction data. For example, and in some embodiments, the node traversal recalibration system may be configured to use the centralized system 512 to update the computational resources using the user interaction data stored in the user interaction data database.

In some embodiments, the centralized system 512 may be configured to update the node traversal map database 414 with call sessions from the user interaction data and establish a more accurate model for the predictive node traversal map model 414 with various call sessions. Further, the channel metrics in the node information database 416 may be updated using the user interaction data such as updating the average handling time of the node, call transfer rate of the nodes, and a number of repetitions for the node traversal recalibration process.

In some embodiments, the centralized system 512 may be configured to utilize supervised deep learning transformer algorithms to train the AI-based pre-trained model using labeled user interaction data stored in the user interaction data database. The supervised deep learning transformer algorithms may establish more precise thresholds to determine whether the current node aligns with the actual user intent, by using the training data (e.g., labeled user interaction data) that encompasses various scenarios of user interaction. Moreover, training the AI-based pre-trained model with recent training data incorporates trends in speech characteristics and terminologies, enabling more accurate decision-making.

In some embodiments, the centralized system 512 may be configured to use supervised deep learning transformer algorithms to train customized AI-based pre-trained models tailored for specific users. For instance, a user may have speech characteristics that deviate from speech clarity. The supervised deep learning transformer algorithms may focus on special cases of user utterances from the user interaction database to train the customized AI-based pre-trained model. Subsequently, the subsystem 514 may be configured to use the customized AI-based pre-trained model to personalize the user interaction.

In some embodiments, the generic pre-trained deep learning model module 520 may be configured to re-train the foundation models using the noise analysis data collected from the noise suppression engine 426 and the utterance analysis data collected from the speech recognition transformer 428, thereby adapting the foundation models to recent trends in language usage and speech styles, and speech variations.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for Artificial Intelligence (AI)-based node traversal recalibration in an interactive voice response (IVR) system, the system comprising:
a memory device with computer-readable program code stored thereon; and
at least one processing device operatively coupled to at least one memory device, wherein executing the computer-readable code is configured to cause the at least one processing device to:
receive, using a contextual verbiage engine, an input, wherein the input is a user utterance or a refined text based on the user utterance;
identify a user intent and an intent module associated with the user intent from the input;
determine a current node based on the user intent and the intent module, and a node traversal map associated with the current node;
determine alignment of the current node with an actual user intent, using an AI-based pre-trained model, based on the node traversal map and node traversal knowledge bases; and
execute, in an instance where the current node fails to align with the actual user intent, an utterance recognition refinement engine, wherein the utterance recognition refinement engine is configured to: receive the user utterance; generate the refined text based on the user utterance; and transmit the refined text to the contextual verbiage engine.

2. The system of claim 1, wherein executing the computer-readable program code is further configured to cause the at least one processing device to:
execute, in an instance where the current node aligns with the actual user intent, the intent module using an application programming interface (API) associated with the intent module.

3. The system of claim 1, wherein the node traversal knowledge bases comprise a node traversal map database, a predictive node traversal map model, a node information database, or at least one of user activity record associated with the user.

4. The system of claim 1, wherein executing the computer-readable program code is further configured to cause the at least one processing device to:
request, using the contextual verbiage engine, a confirmation whether the user intent aligns with the actual user intent to the user via the user device; and
execute the intent module using the API associated with the intent module or the utterance recognition refinement engine,
wherein, in an instance where the user confirms the user intent aligns with the actual user intent, execute the intent module, or
wherein, in an instance where the user confirms the user intent fails to align with the actual user intent, execute the utterance recognition refinement engine.

5. The system of claim 1, wherein executing the computer-readable program code is further configured to cause at least one processing device to use a centralized system, wherein the centralized system comprises computational resources and is configured to:
orchestrate at least one subsystem and the computational resources;
assign the user to the subsystem, wherein the subsystem is configured to interact with the user and customize the computational resources for the user;
receive user interaction data associated with the user from the subsystem; and
update the computational resources based on the user interaction data.

6. The system of claim 1, wherein executing the computer-readable program code is further configured to cause at least one processing device to:
execute training of the AI-based pre-trained model using a supervised deep learning transformer algorithm.

7. The system of claim 1, wherein executing the computer-readable program code is further configured to cause at least one processing device to:
route the user to an agent, in an instance where the repetition of a node traversal recalibration process for the current node exceeds a predefined number.

8. The system of claim 1, wherein executing the computer-readable program code is further configured to cause at least one processing device to use the contextual verbiage engine to:
receive, via the user device, the input from the user in a form of at least one of audio, text, image, or video; and
transmit, via the user device, a response associated with the user intent in the form of at least one of audio, text, image, or video.

9. The system of claim 1, wherein the node information database comprises node information associated with the current node, wherein the node information comprises node rules, an average handling time, and a call transfer rate.

10. A computer program product for AI-based node traversal recalibration in an interactive voice response (IVR) system, wherein the computer program product comprises at least one non-transitory computer-readable medium having computer-readable program code portion embodied therein, the computer-readable program code portions which when executed by a processing device are configured to cause a processor to:
receive, using a contextual verbiage engine, an input, wherein the input is a user utterance or a refined text based on the user utterance;
identify a user intent and an intent module associated with the user intent from the input;
determine a current node based on the user intent and the intent module, and a node traversal map associated with the current node;
determine alignment of the current node with an actual user intent, using an AI-based pre-trained model, based on the node traversal map and node traversal knowledge bases; and
execute, in an instance where the current node fails to align with the actual user intent, an utterance recognition refinement engine, wherein the utterance recognition refinement engine is configured to: receive the user utterance; generate the refined text based on the user utterance; and transmit the refined text to the contextual verbiage engine.

11. The computer program product of claim 10, wherein the processing device is further configured to:
execute, in an instance where the current node aligns with the actual user intent, the intent module using an application programming interface (API) associated with the intent module.

12. The computer program product of claim 10, wherein the node traversal knowledge bases comprise a node traversal map database, a predictive node traversal map model, a node information database, or at least one of user activity record associated with the user.

13. The computer program product of claim 10, wherein the processing device is further configured to use a centralized system, wherein the centralized system comprises computational resources and is configured to:
orchestrate at least one subsystem and the computational resources;
assign the user to the subsystem, wherein the subsystem is configured to interact with the user and customize the computational resources for the user;
receive user interaction data associated with the user from the subsystem; and
update the computational resources based on the user interaction data.

14. The computer program product of claim 10, wherein the node information database comprises node information associated with the current node, wherein the node information comprises node rules, an average handling time, and a call transfer rate.

15. A computer-implemented method for AI-based node traversal recalibration in an interactive voice response (IVR) system the method comprising:
receiving, using a contextual verbiage engine, an input, wherein the input is a user utterance or a refined text based on the user utterance;
identifying a user intent and an intent module associated with the user intent from the input;
determining a current node based on the user intent and the intent module, and a node traversal map associated with the current node;
determining alignment of the current node with an actual user intent, using an AI-based pre-trained model, based on the node traversal map and node traversal knowledge bases; and
executing, in an instance where the current node fails to align with the actual user intent, an utterance recognition refinement engine, wherein the utterance recognition refinement engine is configured to: receive the user utterance; generate the refined text based on the user utterance; and transmit the refined text to the contextual verbiage engine.

16. The computer-implemented method of claim 15, wherein the computer-implemented method is further configured for:
executing, in an instance where the current node aligns with the actual user intent, the intent module using an application programming interface (API) associated with the intent module.

17. The computer-implemented method of claim 15, wherein the node traversal knowledge bases comprise a node traversal map database, a predictive node traversal map model, a node information database, or at least one of user activity record associated with the user.

18. The computer-implemented method of claim 15, wherein the computer-implemented method is further configured for using a centralized system, wherein the centralized system comprises computational resources and is configured for:
orchestrating at least one subsystem and the computational resources;
assigning the user to the subsystem, wherein the subsystem is configured to interact with the user and customize the computational resources for the user;
receiving user interaction data associated with the user from the subsystem; and
updating the computational resources based on the user interaction data.

19. The computer-implemented method of claim 15, wherein the computer-implemented method is further configured for causing the at least one processing device for training the AI-based pre-trained model using a supervised deep learning transformer algorithm.

20. The computer-implemented method of claim 15, wherein the computer-implemented method is further configured for using the contextual verbiage engine for:
receiving, via the user device, the input from the user in a form of at least one of audio, text, image, or video; and
transmitting, via the user device, a response associated with the user intent in the form of at least one of audio, text, image, or video.
